(19) United States
(12) Patent Application Publication
(10) Pub. No.: US 2025/0086978 A1
(43) Pub. Date: Mar. 13, 2025

(54) KERNELIZED BIRD’S EYE VIEW SEGMENTATION FOR MULTI-SENSOR PERCEPTION

(71) Applicant: QUALCOMM Incorporated, San Diego, CA (US)

(72) Inventors: Kiran Bangalore Ravi, Paris (FR); Varun Ravi Kumar, San Diego, CA (US); Senthil Kumar Yogamani, Headford (IE)

(21) Appl. No.: 18/466,460

(22) Filed: Sep. 13, 2023

(51) Int. Cl. G06V 20/56; B60W 60/00; G01S 17/89; G06T 17/05; G06V 10/77

(52) U.S. Cl. CPC G06V 20/56; B60W 60/001; G01S 17/89; G06T 17/05; G06V 10/7715; B60W 2420/408

(57) ABSTRACT

An apparatus includes a memory for storing image data and position data, wherein the image data comprises a set of two-dimensional (2D) camera images, and wherein the position data comprises a set of three-dimensional (3D) point cloud frames. The apparatus also includes processing circuitry in communication with the memory, wherein the processing circuitry is configured to convert the set of 2D camera images into a first 3D representation of a 3D environment corresponding to the image data and the position data, wherein the set of 3D point cloud frames comprises a second 3D representation of the 3D environment. The processing circuitry is also configured to generate, based on the first 3D representation and the second 3D representation, a set of bird's eye view (BEV) feature kernels in a continuous space; and generate, based on the set of BEV feature kernels, an output.

### TECHNICAL FIELD

This disclosure relates to sensor systems, including sensor systems for advanced driver-assistance systems (ADAS).

### BACKGROUND

An autonomous driving vehicle is a vehicle that is configured to sense the environment around the vehicle, such as the existence and location of other objects, and operating without or limited human control. An autonomous driving vehicle may include a Light Detection and Ranging (LiDAR) system or other sensor system for sensing point cloud data indicative of the existence and location of other objects around the autonomous driving vehicle. In some examples, such an autonomous driving vehicle may be referred to as an ego vehicle. A vehicle having an advanced driver-assistance systems (ADAS) is a vehicle that includes systems which may assist a driver in operating the vehicle, such as parking or driving the vehicle.

### SUMMARY

The present disclosure generally relates to techniques and devices for processing image data and position data in a continuous space to generate bird's eye view (BEV) features so that the BEV features indicate one or more characteristics of a three-dimensional (3D) environment that are important for generating an output. Extracting image data BEV features from 2D camera images and extracting position data BEV features from 3D point cloud frames may involve placing BEV features into fixed grids including cells having fixed dimensions. This may cause important information to be “crammed” into a fixed-dimension cell of BEV features in a way the impedes resolution. For example, when features corresponding to a vehicle and features corresponding to a pedestrian are forced into the same cell of a set of BEV features, this may blur important information and prevent the set of BEV features from reflecting important information.

Poor resolution resulting from fixed BEV grids may, for example, result in sets of BEV features not sufficiently identifying pedestrians, traffic signs, and other thin and flat objects. This means that it may be beneficial to extract features in a way that does not rely on fixed grids of BEV features. In one or more examples described in this disclosure, a system may generate one or more kernels of BEV features. Each kernel of the one or more kernels may correspond to an object, class of objects, or other characteristic of a 3D environment. For example, one kernel of BEV features may correspond to vehicles, another kernel may correspond to road markings, and another kernel may correspond to pedestrians. To generate kernels of BEV features, the system may process image data and position data in a continuous space without relying on discrete processing to generate fixed grids of BEV features.

Continuous processing of image data and position data to generate BEV features may involve converting two-dimensional (2D) camera images into 3D representations of a 3D environment. Since point cloud frames already represent 3D representations of the 3D environment, converting 2D camera images into 3D representations of the 3D environment may allow the system to process both image data and position data in a continuous space. Accordingly, generating BEV features based on features extracted from both image data and position data that comprise 3D representations of a 3D environment may involve continuous processing that does not rely on fixed grids of BEV features. However, generating BEV features based on features extracted from 2D camera images, and not 3D representations, may require placing BEV features into a fixed grid according to a discrete process, which can result in loss of resolution.

One way to convert a 2D camera image into a 3D representation of a 3D environment is to apply a depth estimation unit to the camera image to generate one or more perspective view depth maps. A perspective view depth map may comprise a 3D representation of a 2D camera image that indicates a 3D position of one or more objects indicated by the camera image within a 3D environment. That is, perspective depth view maps and point cloud frames may each indicate 3D coordinates of one or more objects. The system may extract features from the point cloud frames and the perspective view depth maps and generate BEV features in a continuous space based on the extracted features in a way that does not rely on fixed BEV feature grids. A system configured to extract features and generate BEV features in a continuous space may be configured to generate kernels of BEV features that indicate information important for generating an output while avoiding poor resolution associated with BEV feature grids.

Another way to convert a 2D camera image into a 3D representation of a 3D environment is to generate a 3D “ray” for each pixel of the camera image, the ray passing through one or more objects in the 3D environment. Each ray may be associated with a depth distribution that indicates a depth of one or more points along the ray. A collection of rays and depth distributions corresponding to a 2D camera image may comprise a 3D feature volume that is a 3D representation of the 3D environment. The system may compress the 3D feature volume to generate image data BEV features corresponding to the 2D camera image without relying on a fixed grid of BEV features.

The techniques of this disclosure may result in improved BEV features generated from image data and/or position data as compared with other systems that do not convert 2D camera images into 3D representations of a 3D environment. For example, by converting 2D camera images into 3D representations of a 3D environment, the system may be configured to process both image data and position data in a continuous space in a way that does not require discrete placement of BEV features into fixed-size cells of a BEV feature grid. Placing many features relating to different objects into the same cell may cause blurring and poor resolution that decreases a quality of BEV features and obscures information that is important for generating an output.

In one example, an apparatus for processing image data and position data includes a memory for storing the image data and the position data, wherein the image data comprises a set of 2D camera images, and wherein the position data comprises a set of 3D point cloud frames. The apparatus also includes processing circuitry in communication with the memory, wherein the processing circuitry is configured to convert the set of 2D camera images into a first 3D representation of a 3D environment corresponding to the image data and the position data, wherein the set of 3D point cloud frames comprises a second 3D representation of the 3D environment. The processing circuitry is also configured to generate, based on the first 3D representation and the second 3D representation, a set of BEV feature kernels in a continuous space and generate, based on the set of BEV feature kernels, an output.

In another example, a method includes converting a set of 2D camera images into a first 3D representation of a 3D environment corresponding to image data and position data, wherein a set of 3D point cloud frames comprises a second 3D representation of the 3D environment, wherein a memory is configured to store the image data and the position data, wherein the image data comprises the set of 2D camera images, and wherein the position data comprises the set of 3D point cloud frames. The method also includes generating, based on the first 3D representation and the second 3D representation, a set of BEV feature kernels in a continuous space and generating, based on the set of BEV feature kernels, an output.

In another example, a computer-readable medium stores instructions that, when applied by processing circuitry, causes the processing circuitry to convert a set of 2D camera images into a first 3D representation of a 3D environment corresponding to image data and position data, wherein a set of 3D point cloud frames comprises a second 3D representation of the 3D environment, wherein a memory is configured to store the image data and the position data, wherein the image data comprises the set of 2D camera images, and wherein the position data comprises the set of 3D point cloud frames. The instructions also cause the processing circuitry to generate, based on the first 3D representation and the second 3D representation, a set of BEV feature kernels in a continuous space and generate, based on the set of BEV feature kernels, an output.

The details of one or more examples are set forth in the accompanying drawings and the description below. Other features, objects, and advantages will be apparent from the description, drawings, and claims.

### BRIEF DESCRIPTION OF DRAWINGS

FIG. 1 is a block diagram illustrating an example processing system, in accordance with one to more techniques of this disclosure.

FIG. 2 is a block diagram illustrating a first encoder-decoder architecture for processing image data and position data in a continuous space to generate an output, in accordance with one to more techniques of this disclosure.

FIG. 3 is a block diagram illustrating a second encoder-decoder architecture for processing image data and position data in a continuous space to generate an output, in accordance with one to more techniques of this disclosure.

FIG. 4 is a conceptual diagram illustrating an example ray-to-bird's eye view unit, in accordance with one or more techniques of this disclosure.

FIG. 5 is a conceptual diagram illustrating a system for using an example feature fusion unit to generate fused grid-free BEV feature kernels, in accordance with one or more techniques of this disclosure.

FIG. 6 is a flow diagram illustrating an example method for generating BEV features based on converting image data into a three-dimensional (3D) representation of a 3D environment, in accordance with one or more techniques of this disclosure.

### DETAILED DESCRIPTION

Camera and Light Detection and Ranging (LiDAR) systems may be used together in various different robotic, vehicular, and virtual reality (VR). One such vehicular application is an advanced driver assistance system (ADAS). ADAS is a system that utilizes both camera and LiDAR sensor technology to improve driving safety, comfort, and overall vehicle performance. This system combines the strengths of both sensors to provide a more comprehensive view of a vehicle's surroundings, enabling the ADAS to better assist the driver in various driving scenarios.

In some examples, the camera-based system is responsible for capturing high-resolution images and processing them in real time. The output images of such a camera-based system may be used in applications such as depth estimation, object detection, and/or pose detection, including the detection and recognition of objects, such as other vehicles, pedestrians, traffic signs, and lane markings. Cameras may be particularly good at capturing color and texture information, which is useful for accurate object recognition and classification.

LiDAR sensors emit laser pulses to measure the distance, shape, and relative speed of objects around the vehicle. LiDAR sensors provide three-dimensional (3D) data, enabling the ADAS to create a detailed map of the surrounding environment. LiDAR may be particularly effective in low-light or adverse weather conditions, where camera performance may be hindered. In some examples, the output of a LiDAR sensor may be used as partial ground truth data for determining neural network-based depth information on corresponding camera images.

By fusing the data gathered from both camera and LiDAR sensors, an ADAS or another kind of system can deliver enhanced situational awareness and improved decision-making capabilities. This enables various driver assistance features such as adaptive cruise control, lane keeping assist, pedestrian detection, automatic emergency braking, and parking assistance. The combined system can also contribute to the development of semi-autonomous and fully autonomous driving technologies, which may lead to a safer and more efficient driving experience.

The present disclosure generally relates to techniques and devices for generating bird's eye view (BEV) features based on position data collected by a LiDAR sensor (e.g., a 3D point cloud), generating BEV features based on image data captured by a camera (e.g., a two-dimensional (2D) image), and fusing the BEV features. As described above, cameras and LiDAR sensors may be used in vehicular, robotic, and VR applications as sources of information that may be used to determine the location, pose, and potential actions of physical objects in the outside world. However, generating BEV features based on 2D camera images may involve generating fixed grids of image data BEV features and fixed grids of position data BEV features. In some cases, many features relating to different objects may be placed into the same cell of a fixed grid of BEV features, leading to blurring and poor resolution. This disclosure describes techniques for processing image data and position data in a continuous space to generate features in a way that does not rely on fixed grids of BEV features. For example, a system may generate kernels of BEV features including the most important information for each object, class of objects, or other characteristics of a 3D environment. Additionally, or alternatively, the system may generate a BEV image in a continuous space.

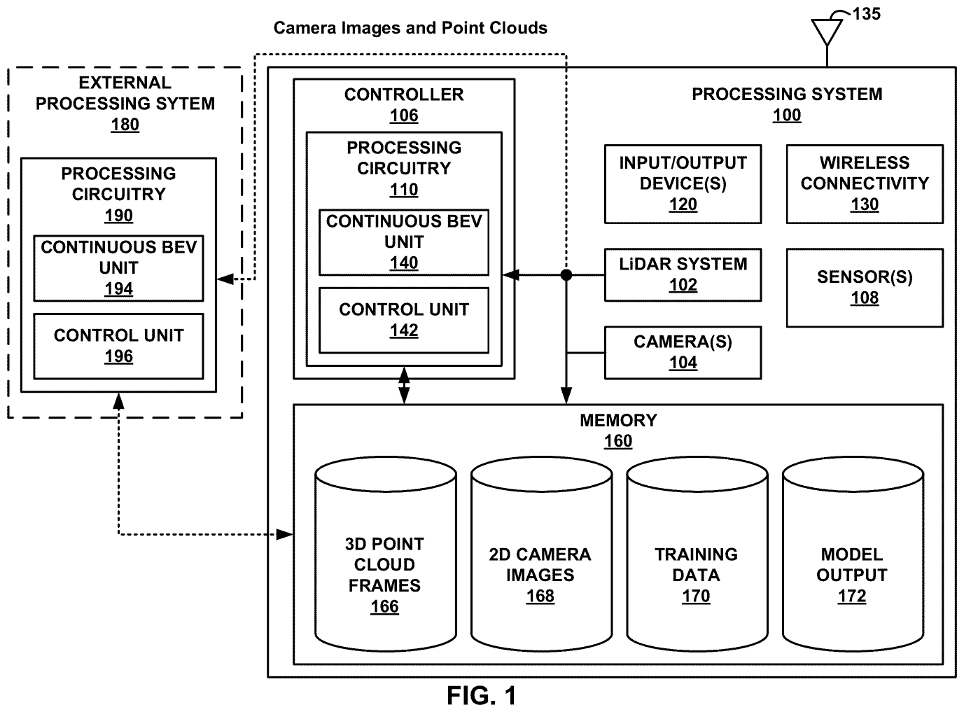

FIG. 1 is a block diagram illustrating an example processing system 100, in accordance with one to more techniques of this disclosure. Processing system 100 may be used in a vehicle, such as an autonomous driving vehicle or an assisted driving vehicle (e.g., a vehicle having an ADAS or an “ego vehicle”). In such an example, processing system 100 may represent an ADAS. In other examples, processing system 100 may be used in robotic applications, virtual reality (VR) applications, or other kinds of applications that may include both a camera and a LiDAR system. The techniques of this disclosure are not limited to vehicular applications. The techniques of this disclosure may be applied by any system that processes image data and/or position data.

Processing system 100 may include LiDAR system 102, camera(s) 104, controller 106, one or more sensor(s) 108, input/output device(s) 120, wireless connectivity component 130, and memory 160. LiDAR system 102 may include one or more light emitters (e.g., lasers) and one or more light sensors. LiDAR system 102 may, in some cases, be deployed in or about a vehicle. For example, LiDAR system 102 may be mounted on a roof of a vehicle, in bumpers of a vehicle, and/or in other locations of a vehicle. LiDAR system 102 may be configured to emit light pulses and sense the light pulses reflected off of objects in the environment. LiDAR system 102 is not limited to being deployed in or about a vehicle. LiDAR system 102 may be deployed in or about another kind of object.

In some examples, the one or more light emitters of LiDAR system 102 may emit such pulses in a 360-degree field around the vehicle so as to detect objects within the 360-degree field by detecting reflected pulses using the one or more light sensors. For example, LiDAR system 102 may detect objects in front of, behind, or beside LiDAR system 102. While described herein as including LiDAR system 102, it should be understood that another distance or depth sensing system may be used in place of LiDAR system 102. The output of LiDAR system 102 are called point clouds or point cloud frames.

A point cloud frame output by LiDAR system 102 is a collection of 3D data points that represent the surface of objects in the environment. LiDAR processing circuitry of LiDAR system 102 may generate one or more point cloud frames mased on the one or more optical signals emitted by the one or more light emitters of LiDAR system 102 and the one or more reflected optical signals sensed by the one or more light sensors of LiDAR system 102. These points are generated by measuring the time it takes for a laser pulse to travel from a light emitter to an object and back to a light detector. Each point in the cloud has at least three attributes: x, y, and z coordinates, which represent its position in a Cartesian coordinate system. Some LiDAR systems also provide additional information for each point, such as intensity, color, and classification.

Intensity (also called reflectance) is a measure of the strength of the returned laser pulse signal for each point. The value of the intensity attribute depends on various factors, such as the reflectivity of the object's surface, distance from the sensor, and the angle of incidence. Intensity values can be used for several purposes, including distinguishing different materials, and enhancing visualization: Intensity values can be used to generate a grayscale image of the point cloud, helping to highlight the structure and features in the data.

Color information in a point cloud is usually obtained from other sources, such as digital cameras mounted on the same platform as the LiDAR sensor, and then combined with the LiDAR data. Cameras used to capture color information for point cloud data may, in some examples, be separate from camera(s) 104. The color attribute includes color values (e.g., red, green, and blue (RGB)) values for each point. The color values may be used to improve visualization and aid in enhanced classification (e.g., the color information can aid in the classification of objects and features in the scene, such as vegetation, buildings, and roads.)

Classification is the process of assigning each point in the point cloud to a category or class based on its characteristics or its relation to other points. The classification attribute may be an integer value that represents the class of each point, such as ground, vegetation, building, water, etc. Classification can be performed using various algorithms, often relying on machine learning techniques or rule-based approaches.

Camera(s) 104 may include any type of camera configured to capture video or image data in the environment around processing system 100 (e.g., around a vehicle). In some examples, processing system 100 may include multiple camera(s) 104. For example, camera(s) 104 may include a front facing camera (e.g., a front bumper camera, a front windshield camera, and/or a dashcam), a back facing camera (e.g., a backup camera), side facing cameras (e.g., cameras mounted in sideview mirrors). Camera(s) 104 may be a color camera or a grayscale camera. In some examples, camera(s) 104 may be a camera system including more than one camera sensor. While techniques of this disclosure will be described with reference to a 2D photographic camera, the techniques of this disclosure may be applied to the outputs of other sensors that capture information at a higher frame rate than a LiDAR sensor, including a sonar sensor, a radar sensor, an infrared camera, and/or a time-of-flight (ToF) camera.

LiDAR system 102 may, in some examples, be configured to collect 3D point cloud frames 166. Camera(s) 104 may, in some examples, be configured to collect 2D camera images 168. An importance of data input modalities such as 3D point cloud frames 166 and 2D camera images 168 may vary for indicating one or more characteristics of objects in a 3D environment. For example, when color and texture are important characteristics of a first object and when color and texture are not important characteristics of a second object, 2D camera images 168 may be more important for identifying characteristics of the first object as compared with the importance of 3D point cloud frames 166 for identifying characteristics of the second object. It may be beneficial to consider the importance of 3D point cloud frames 166 and 2D camera images 168 for indicating characteristics of a 3D environment when generating BEV features corresponding to 3D point cloud frames 166 and/or generating BEV features corresponding to 2D camera images 168.

Wireless connectivity component 130 may include subcomponents, for example, for third generation (3G) connectivity, fourth generation (4G) connectivity (e.g., 4G Long Term Evolution (LTE)), fifth generation (5G) connectivity (e.g., 5G or New Radio (NR)), Wi-Fi connectivity, Bluetooth connectivity, and other wireless data transmission standards. Wireless connectivity component 130 is further connected to one or more antennas 135.

Processing system 100 may also include one or more input/output devices 120, such as screens, touch-sensitive surfaces (including touch-sensitive displays), physical buttons, speakers, microphones, and the like. Input/output device(s) 120 (e.g., which may include an I/O controller) may manage input and output signals for processing system 100. In some cases, input/output device(s) 120 may represent a physical connection or port to an external peripheral. In some cases, input/output device(s) 120 may utilize an operating system. In other cases, input/output device(s) 120 may represent or interact with a modem, a keyboard, a mouse, a touchscreen, or a similar device. In some cases, input/output device(s) 120 may be implemented as part of a processor (e.g., a processor of processing circuitry 110). In some cases, a user may interact with a device via input/output device(s) 120 or via hardware components controlled by input/output device(s) 120.

Controller 106 may be an autonomous or assisted driving controller (e.g., an ADAS) configured to control operation of processing system 100 (e.g., including the operation of a vehicle). For example, controller 106 may control acceleration, braking, and/or navigation of vehicle through the environment surrounding vehicle. Controller 106 may include one or more processors, e.g., processing circuitry 110. Controller 106 is not limited to controlling vehicles. Controller 106 may additionally or alternatively control any kind of controllable device, such as a robotic component. Processing circuitry 110 may include one or more central processing units (CPUs), such as single-core or multi-core CPUs, graphics processing units (GPUs), digital signal processor (DSPs), application specific integrated circuits (ASICs), field programmable gate arrays (FPGAs), neural processing unit (NPUs), multimedia processing units, and/or the like. Instructions applied by processing circuitry 110 may be loaded, for example, from memory 160 and may cause processing circuitry 110 to perform the operations attributed to processor(s) in this disclosure.

An NPU is generally a specialized circuit configured for implementing control and arithmetic logic for executing machine learning algorithms, such as algorithms for processing artificial neural networks (ANNs), deep neural networks (DNNs), random forests (RFs), kernel methods, and the like. An NPU may sometimes alternatively be referred to as a neural signal processor (NSP), a tensor processing unit (TPU), a neural network processor (NNP), an intelligence processing unit (IPU), or a vision processing unit (VPU).

Processing circuitry 110 may also include one or more sensor processing units associated with LiDAR system 102, camera(s) 104, and/or sensor(s) 108. For example, processing circuitry 110 may include one or more image signal processors associated with camera(s) 104 and/or sensor(s) 108, and/or a navigation processor associated with sensor(s) 108, which may include satellite-based positioning system components (e.g., Global Positioning System (GPS) or Global Navigation Satellite System (GLONASS)) as well as inertial positioning system components. Sensor(s) 108 may include direct depth sensing sensors, which may function to determine a depth of or distance to objects within the environment surrounding processing system 100 (e.g., surrounding a vehicle).

Processing system 100 also includes memory 160, which is representative of one or more static and/or dynamic memories, such as a dynamic random-access memory, a flash-based static memory, and the like. In this example, memory 160 includes computer-executable components, which may be applied by one or more of the aforementioned components of processing system 100.

Examples of memory 160 include random access memory (RAM), read-only memory (ROM), electrically erasable programmable ROM (EEPROM), compact disk ROM (CD-ROM), or another kind of hard disk. Examples of memory 160 include solid state memory and a hard disk drive. In some examples, memory 160 is used to store computer-readable, computer-executable software including instructions that, when applied, cause a processor to perform various functions described herein. In some cases, memory 160 contains, among other things, a basic input/output system (BIOS) which controls basic hardware or software operation such as the interaction with peripheral components or devices. In some cases, a memory controller operates memory cells of memory 160. For example, the memory controller can include a row decoder, column decoder, or both. In some cases, memory cells within memory 160 store information in the form of a logical state.

Processing system 100 may be configured to perform techniques for extracting features from image data and position data, processing the features, fusing the features, or any combination thereof. For example, processing circuitry 110 may include continuous BEV unit 140. Continuous BEV unit 140 may be implemented in software, firmware, and/or any combination of hardware described herein. As will be described in more detail below, Continuous BEV unit 140 may be configured to receive a plurality of 2D camera images 168 captured by camera(s) 104 and receive a plurality of 3D point cloud frames 166 captured by LiDAR system 102. Continuous BEV unit 140 may be configured to receive 2D camera images 168 and 3D point cloud frames 166 directly from camera(s) 104 and LiDAR system 102, respectively, or from memory 160. In some examples, the plurality of 3D point cloud frames 166 may be referred to herein as “position data.” In some examples, the plurality of 2D camera images 168 may be referred to herein as “image data.”

In general, continuous BEV unit 140 may fuse features corresponding to the plurality of 3D point cloud frames 166 and features corresponding to the plurality of 2D camera images 168 in order to combine image data corresponding to one or more objects within a 3D space with position data corresponding to the one or more objects. For example, each camera image of the plurality of 2D camera images 168 may comprise a 2D array of pixels that includes image data corresponding to one or more objects. Each point cloud frame of the plurality of 3D point cloud frames 166 may include a 3D multi-dimensional array of points corresponding to the one or more objects. Since the one or more objects are located in the same 3D space where processing system 100 is located, it may be beneficial to fuse features of the image data present in 2D camera images 168 that indicate information corresponding to the identity one or more objects with features of the position data present in the 3D point cloud frames 166 that indicate a location of the one or more objects within the 3D space. This is because image data may include at least some information that position data does not include, and position data may include at least some information that image data does not include.

Fusing features of image data and features of position data may provide a more comprehensive view of a 3D environment corresponding to processing system 100 as compared with analyzing features of image data and features of position data separately. For example, the plurality of 3D point cloud frames 166 may indicate an object in front of a processing system 100, and continuous BEV unit 140 may be able to process the plurality of 3D point cloud frames 166 to determine that the object is a stoplight. This is because the plurality of 3D point cloud frames 166 may indicate that the object includes three round components oriented vertically and/or horizontally relative to a surface of a road intersection, and the plurality of 3D point cloud frames 166 may indicate that the size of the object is within a range of sizes that stoplights normally occupy. But the plurality of 3D point cloud frames 166 might not include information that indicates which of the three lights of the stoplight is turned on and which of the three lights of the stoplight is turned off. 2D camera images 168 may include image data indicating that a green light of the stoplight is turned on, for example. This means that it may be beneficial to fuse features of image data with features of position data so that continuous BEV unit 140 can analyze image data and position data to determine characteristics of one or more objects within the 3D environment.

Fusing image data BEV features and position data BEV features may involve associating image data BEV features with position data BEV features corresponding to the image data BEV features. For example, processing system 100 may fuse image data BEV features indicating a color and an identity of a stoplight with position data BEV features indicating a position of the stoplight. This means that the fused set of BEV features may include information from both image data and position data corresponding to the stoplight that is important for generating an output. Some systems may fuse image data BEV features with position data BEV features by generating “grids” of image data BEV features with position data BEV features and fusing the grids. A BEV feature grid may correspond to a 2D bird's eye view of a 3D environment. Each “cell” of the BEV feature grid may include features corresponding to a portion of the 3D environment corresponding to the cell. This allows the system to fuse image data BEV features with position data BEV features corresponding to the same portion of the 3D environment.

In some examples, generating fixed grids of BEV features may cause features corresponding to different objects within the 3D environment to be placed within the same BEV grid cell. For example, when a fixed grid of BEV features includes a set of cells each having fixed dimensions, features corresponding to objects within a space corresponding to the fixed dimensions of a cell may be placed in the same cell. When features corresponding to many objects are placed into the same cell, this may cause the set of BEV features to have poor resolution in a way that prevents the set of BEV features from including important information corresponding to all of the objects in the 3D environment.

BEV grid resolution may be chosen to reduce memory consumption similar to how voxel grid sizes are chosen in point cloud DNN architectures. In some examples, a fixed grid size may be 128 cells by 128 cells with a resolution of 80 centimeters (cm) for each cell in the grid. Low-resolution BEV grids may lead to poor resolution coarse features being extracted. This may lead to poor detection of images. Features extracted in the BEV grid may be sensitive to grid resolution. Poor resolution may result in poor detection of pedestrians, traffic signs and other thin and flat objects, while lanes/roads segments with larger surface area in BEV may be detected better. BEV fusion models may use an up-sampling layer to handle low resolution grids.

Continuous BEV unit 140 may generate BEV features in a way that does not rely on fixed grids of BEV features to fuse image data BEV features and position data BEV features. For example, continuous BEV unit 140 may convert one or more 2D camera images of 2D camera images 168 into a 3D representation of a 3D environment corresponding to 3D point cloud frames 166 and 2D camera images 168. For example, 3D point cloud frames 166 and 2D camera images 168 may both indicate information corresponding to the same 3D environment, but 2D camera images 168 may present information in the form of 2D arrays of pixels, and 3D point cloud frames 166 may present information in the form of 3D spaces including “points” having 3D coordinates. That is, 3D point cloud frames 166 may represent a 3D representation of the 3D environment and 2D camera images 168 may represent a 2D representation of the 3D environment.

Converting one or more of the 2D camera images 168 into 3D representations of the 3D environment may allow the continuous BEV unit 140 to process both 3D point cloud frames 166 and 2D camera images 168 in a continuous space to generate BEV features in a way that dopes not rely on fixed grids of BEV features. For example, continuous BEV unit 140 may process features extracted from 3D point cloud frames 166 and 2D camera images 168 to generate BEV features including a set of kernels. Each kernel of the set of kernels may include BEV features corresponding to an object, a class of objects, or another standalone characteristic of the 3D environment. That is, the set of kernels may indicate information corresponding to each characteristic and/or object of the 3D environment that is important for generating an output without placing features corresponding to many different objects within the same cell of a BEV feature grid. In this way, continuous BEV unit 140 may prevent BEV features from having poor resolution associated with fixed BEV feature grids.

In some examples, to convert the one or more 2D camera images of 2D camera images 168 into a 3D representation of the 3D environment corresponding to 3D point cloud frames 166 and 2D camera images 168, continuous BEV unit 140 may apply a depth estimation unit to generate, based on one or more 2D camera images, a set of perspective view depth maps. Each perspective view depth map of the one or more perspective view depth map may represent a 3D representation of the 3D environment. The one or more perspective view depth maps corresponding to the 2D camera images 168 may indicate 3D positions of one or more objects within the 3D environment. This means that both of the perspective view depth maps and the 3D point cloud frames 166 indicate position data.

A depth estimation unit may include one or more encoders and one or more decoders. To apply the depth estimation unit to generate one or more perspective view depth maps, continuous BEV unit 140 is configured to apply the one or more encoders and one or more decoders to generate the one or more perspective view depth maps to indicate a location of one or more objects indicated by the image data within the 3D environment. That is, the one or more encoders and the one or more decoders of the depth estimation unit may expand a 2D array of pixels into a 3D space including a collection of 3D coordinates. The 3D coordinates may indicate positions of objects within the 3D space.

In some examples, continuous BEV unit 140 is configured to generate, based on the 3D point cloud frames 166 and the one or more perspective view depth maps corresponding to 2D camera images 168, a set BEV features. The set of BEV features may comprise a 2D representation of the 3D environment. For example, the set of BEV features may indicate information corresponding to one or more objects within the 3D environment from a view above the one or more objects looking down at the one or more objects. This may allow controller 106 to control a device within the 3D environment based on information indicated by the set of BEV features.

In some examples, to generate the set BEV features, continuous BEV unit 140 may apply a first feature extractor to extract, from the one or more perspective view depth maps corresponding to the 2D camera images 168, a first set of 3D features. Continuous BEV unit 140 may apply a second feature extractor to extract, from 3D point cloud frames 166, a second set of 3D features. Since the perspective view depth maps are 3D representations of the 3D environment, features extracted from the perspective view depth maps may represent 3D features. This means that features extracted from the perspective view depth maps and features extracted from the 3D point cloud frames 166 may both represent 3D features that continuous BEV unit 140 may be configured to fuse and process using continuous convolution. Continuous BEV unit 140 may use continuous convolution to process the 3D features to generate the set of BEV features instead of relying on fixed BEV feature grids to generate the set of BEV features.

To generate the set BEV features based on the 3D features extracted from the perspective view depth maps and the 3D features extracted from the 3D point cloud frames 166, continuous BEV unit 140 may fuse the 3D features extracted from the perspective view depth maps and the 3D features extracted from the 3D point cloud frames 166. Since both sets of 3D features indicate locations of objects within a 3D space, continuous BEV unit 140 may fuse features based on locations within the 3D space. In some examples, continuous BEV unit 140 may apply a first spatial transformer to the 3D features extracted from the perspective view depth maps and apply a second spatial transformer to the 3D features extracted from the 3D point cloud frames 166, and fuse the outputs from the spatial transformers.

Continuous BEV unit 140 may apply a continuous convolution decoder to the fused set of 3D features to generate a processed fused set of 3D features. In some examples, the continuous convolution decoder may process the set of 3D features in a continuous space without relying on fixed grids of BEV features. For example, using fixed grids of BEV cells may result in poor resolution. Using a continuous convolution decoder to process the set of 3D features may allow continuous BEV unit 104 to avoid using fixed grids of BEV features and improve resolution. In some examples, continuous BEV unit 140 may compress the output from the continuous convolution decoder to generate a set of kernels of BEV features. Each kernel of the set of kernels may include BEV features corresponding to an object or another characteristic of the 3D environment. Generating the set of kernels may ensure that the set of BEV features include important information for each object without information from different objects blurring together. In continuous convolution, the convolution process may occur without boundaries other than a start and an end of image data. In a discrete convolution process relying on fixed grids of BEV features, in some cases only a subset of the image data is processed based only on information present in the grid.

In some examples, to convert 2D camera images 168 into a 3D representation of a 3D environment, continuous BEV unit 140 may apply a feature extractor to extract, from 2D camera images 168, a set of perspective view features. In some examples, the set of perspective view features may represent 2D features from a perspective of camera(s) 104 that capture 2D camera images 168. This means that converting 2D camera images 168 into a 3D representation of the 3D environment may facilitate processing image data in a continuous space without relying on fixed BEV grids much like continuous BEV unit 140 processes 3D point cloud frames 166 without relying on fixed BEV grids. Processing image data in a continuous space may involve processing image data without boundaries. Processing image data discretely may involve processing data in a way that relies on fixed grids of BEV features. By processing image data and position data in a continuous space to generate BEV features, continuous BEV unit 140 may avoid relying on fixed grids of BEV features and thus avoid blurring and poor resolution associated with cramming features relating to many different objects into the same fixed-dimension BEV feature cell.

Continuous BEV unit 140 may generate, based on the 2D camera images 168, a 3D feature volume. In some examples, the 3D feature volume may represent a 3D representation of the 3D environment that includes a plurality of points within the 3D representation of the 3D environment. This means that points within the 3D feature volume may correspond to points within the 3D point cloud frames 166. Continuous BEV unit may populate the 3D feature volume with the set of perspective view features extracted from the 2D camera images to create a populated 3D feature volume. The populated 3D volume may include features that correspond to features extracted from the 3D point cloud frames 166.

In some examples, to generate a 3D feature volume based on a 2D camera image of 2D camera images 168, continuous BEV unit 140 is configured to create, based on each camera image pixel of the 2D camera image, a line through a 3D space. This line may be referred to herein as a “ray.” Continuous BEV unit 140 may identify, for the ray corresponding to each camera image pixel of 2D camera image of the set of 2D camera images 168, one or more points within the 3D space. Continuous BEV unit 140 is configured to create, for the one or more points of each ray corresponding to the set of 2D camera images, a depth distribution. A depth distribution may indicate locations of one or more objects within the 2D camera image within the 3D environment. For example, although the 2D camera image of 2D camera images 168 might not indicate the 3D position of objects, the depth distribution corresponding to the 3D feature volume indicates the 3D position of objects within the 3D environment. This allows the continuous BEV unit 140 to populate the 3D feature volume with perspective view features extracted from 2D camera images to create 3D features for image data that is similar to the 3D features extracted from 3D point cloud frames 166.

To generate a set of BEV features based on the 3D feature volume corresponding to 2D camera images 168, continuous BEV unit 140 may apply a feature extractor to extract, from 3D point cloud frames 166, a 3D feature volume. In some examples, the 3D feature volume extracted from the 3D point cloud frames 166 may be similar to the 3D feature volumes generated based on 2D camera images 168 and perspective view features extracted from 2D camera images 168 because both 3D feature volumes indicate information corresponding to one or more objects based on the position of the one or more objects within a 3D environment. Since both of the 3D feature volumes indicate information corresponding to one or more objects based on the position of the one or more objects within a 3D environment, continuous BEV unit 140 may be configured to process 3D point cloud frames 166 and 2D camera images 168 in a continuous space without relying on fixed grids of BEV data.

Continuous BEV unit 140 may compress the 3D feature volume corresponding to 2D camera images 168 to generate a set of image data BEV features. Continuous BEV unit 140 may compress the 3D feature volume corresponding to 3D point cloud frames 166 to generate a set of position data BEV features. The set of image data BEV features and the set of position data BEV features may correspond to a 2D bird's eye view of one or more objects within the 3D environment without a fixed grid of cells. Continuous BEV unit 140 may fuse the set of image data BEV features and the set of position data BEV features to generate a fused set of BEV features.

In some examples, processing circuitry 110 may be configured to train one or more encoders, decoders, or any combination thereof applied by continuous BEV unit 140 using training data 170. For example, training data 170 may include one or more training point cloud frames and/or one or more camera images. Training data 170 may additionally or alternatively include features known to accurately represent one or more point cloud frames and/or features known to accurately represent one or more camera images. This may allow processing circuitry 110 to train one or more encoders to generate features that accurately represent point cloud frames and train one or more encoders to generate features that accurately represent camera images. Processing circuitry 110 may also use training data 170 to train one or more decoders. In some examples, training data 170 may be stored separately from processing system 100. In some examples, processing circuitry other than processing circuitry 110 and/or processing circuitry 190 and separate from processing unit 100 may train one or more encoders, decoders, or any combination thereof applied by continuous BEV unit 140 using training data 170.

Processing circuitry 110 of controller 106 may apply control unit 142 to control, based on the output generated by continuous BEV unit 140 by applying the third decoder to the fused sets of reweighed BEV features, a device (e.g., a vehicle, a robotic arm, or another device that is controllable based on the output from continuous BEV unit 140) corresponding to processing system 100. Control unit 142 may control the device based on information included in the output generated by continuous BEV unit 140 relating to one or more objects within a 3D space including processing system 100. For example, the output generated by continuous BEV unit 140 may include an identity of one or more objects, a position of one or more objects relative to the processing system 100, characteristics of movement (e.g., speed, acceleration) of one or more objects, or any combination thereof. Based on this information, control unit 142 may control the device corresponding to processing system 100. The output from continuous BEV unit 140 may be stored in memory 160 as model output 172.

The techniques of this disclosure may also be performed by external processing system 180. That is, encoding input data, transforming features into BEV features, weighing features, fusing features, and decoding features, may be performed by a processing system that does not include the various sensors shown for processing system 100. Such a process may be referred to as “offline” data processing, where the output is determined from a set of test point clouds and test images received from processing system 100. External processing system 180 may send an output to processing system 100 (e.g., an ADAS or vehicle).

External processing system 180 may include processing circuitry 190, which may be any of the types of processors described above for processing circuitry 110. Processing circuitry 190 may include a continuous BEV unit 194 is configured to perform the same processes as continuous BEV unit 140. Processing circuitry 190 may acquire 3D point cloud frames 166 and camera images 168 directly from LiDAR system 102 and camera(s) 104, respectively, or from memory 160. Though not shown, external processing system 180 may also include a memory that may be configured to store point cloud frames, camera images, model outputs, among other data that may be used in data processing. Continuous BEV unit 194 may be configured to perform any of the techniques described as being performed by continuous BEV unit 140. Control unit 196 may be configured to perform any of the techniques described as being performed by control unit 142.

BEV representation is an important part of multi-sensor representation learning across camera and LiDAR sensors for downstream tasks such as 3D object detection and BEV semantic segmentation. Multicamera BEV DNNs may include camera feature extractor or Backbone, perspective-to-BEV feature projection (2D-to-BEV) that creates BEV grids of fixed resolution and cell size, feature fusion across multiple cameras in a camera rig, feature fusion across camera-LiDAR in a multi-sensor system, or any combination thereof. Standard BEV perception and fusion modules may suffer from a fixed grid size and resolution. Discretization of grids and voxelization may be a key problem in point cloud and 3D camera perception pipelines. Transforming 2D camera images into a 3D representation of the 3D environment corresponding to processing system 100 may allow continuous BEV unit 140 to process features without fixed grids.

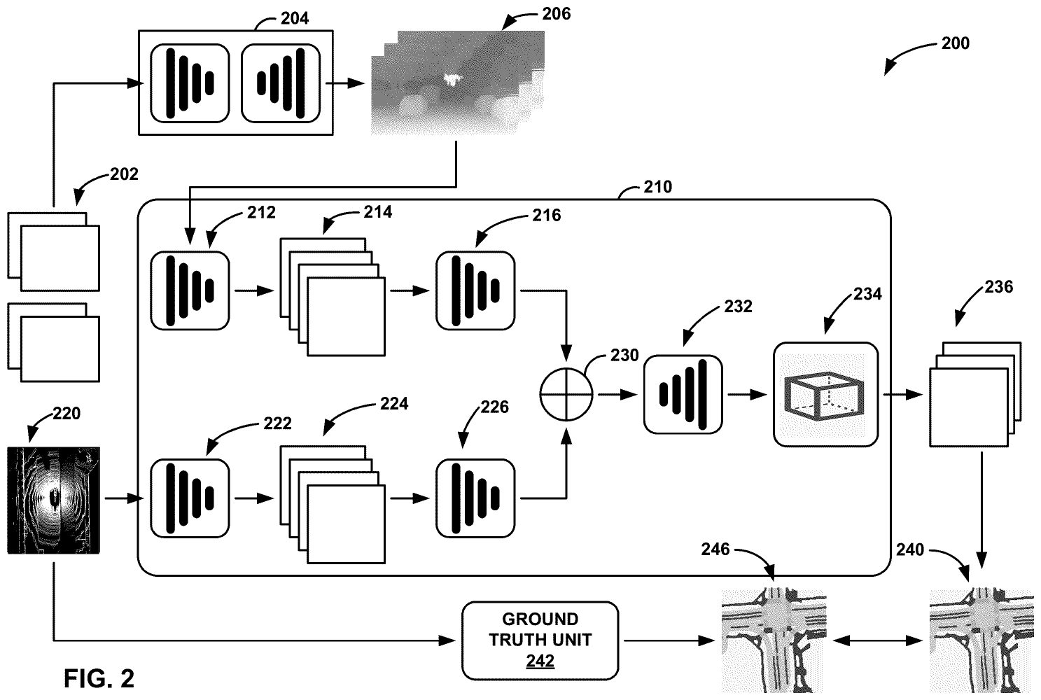

FIG. 2 is a block diagram illustrating a first encoder-decoder architecture 200 for processing image data and position data in a continuous space to generate an output, in accordance with one to more techniques of this disclosure. In some examples, first encoder-decoder architecture 200 may be a part of continuous BEV unit 140 and/or continuous BEV unit 194 of FIG. 1. FIG. 2 illustrates 2D camera images 202, depth estimation unit 204, perspective view depth maps 206, BEV feature kernel unit 210, 3D point cloud frames 220, BEV feature kernels 236, output 240, ground truth unit 242, and kernelized ground truth 246. BEV feature kernel unit 210 includes first feature extractor 212, first 3D features 214, first spatial transformer 216, second feature extractor 222, second 3D features 224, second spatial transformer 226, feature fusion unit 230, continuous convolution decoder 232, and flattening unit 234.

2D camera images 202 may be examples of 2D camera images 168 of FIG. 1. In some examples, 2D camera images 202 may represent a set of camera images from 2D camera images 168 and 2D camera images 168 may include one or more camera images that are not present in 2D camera images 202. In some examples, 2D camera images 202 may be received from a plurality of cameras at different locations and/or different fields of view, which may be overlapping. In some examples, first encoder-decoder architecture 200 processes 2D camera images 202 in real time or near real time so that as camera(s) 104 captures 2D camera images 202, and first encoder-decoder architecture 200 processes the captured camera images. In some examples, 2D camera images 202 may represent one or more perspective views of one or more objects within a 3D space where processing system 100 is located. That is, the one or more perspective views may represent views from the perspective of processing system 100.

In some examples, first encoder-decoder architecture 200 may be configured to convert the set of 2D camera images 202 into a first 3D representation of a 3D environment corresponding to 2D camera images 202 and 3D point cloud frames 220. 3D point cloud frames 220 may represent a second 3D representation of the 3D environment. In this way, first encoder-decoder architecture 200 may cause both 2D camera images 202 and the 3D point cloud frames 220 to be a 3D representation of the 3D environment. This may allow first encoder-decoder architecture 200 to process features extracted from 2D camera images 202 and the 3D point cloud frames 220 in a continuous space without using discrete processing that relies on 2D grids of features. For example, first encoder-decoder architecture 200 may generate a set of BEV features. Although the set of BEV features may include a 2D representation of the 3D environment, the set of BEV features might not rely on a 2D grid of BEV feature cells that place features corresponding to many different objects in the same cell.

First encoder-decoder architecture 200 includes one or more encoders (e.g., feature extractors 212, 222, spatial transformers 216, 226) and one or more decoders (e.g., continuous convolution decoder 232). First encoder-decoder architecture 200 may be configured to process image data and position data (e.g., point cloud data). An encoder-decoder architecture for image feature extraction can be used in computer vision tasks, such as image captioning, image-to-image translation, and image generation. The encoder-decoder architecture may transform input data into a compact and meaningful representation known as a feature vector that captures salient visual information from the input data. The encoder may extract features from the input data, while the decoder reconstructs the input data from the learned features.

In some cases, an encoder (e.g., feature extractors 212, 222, spatial transformers 216, 226) is built using convolutional neural network (CNN) layers to analyze input data in a hierarchical manner. The CNN layers may apply filters to capture local patterns and gradually combine them to form higher-level features. Each convolutional layer extracts increasingly complex visual representations from the input data. These representations may be compressed and down sampled through operations such as pooling or strided convolutions, reducing spatial dimensions while preserving desired information. The final output of the encoder may represent a flattened feature vector that encodes the input data's high-level visual features.

A decoder (e.g., continuous convolution decoder 232) may be built using transposed convolutional layers or fully connected layers, may reconstruct the input data from the learned feature representation. A decoder may take the feature vector obtained from the encoder as input and processes the feature vector to generate an output that is similar to the input data. The decoder may up-sample and expand the feature vector, gradually recovering spatial dimensions lost during encoding. A decoder may apply transformations, such as transposed convolutions or deconvolutions, to reconstruct the input data. The decoder layers progressively refine the output, incorporating details and structure until a visually plausible image is generated.

During training, an encoder-decoder architecture for feature extraction is trained using a loss function that measures the discrepancy between the reconstructed image and the ground truth image. This loss guides the learning process, encouraging the encoder to capture meaningful features and the decoder to produce accurate reconstructions. The training process may involve minimizing the difference between the generated image and the ground truth image, typically using backpropagation and gradient descent techniques. Encoders and decoders of first encoder-decoder architecture 200 may be trained using training data 170 stored by the memory 160 of FIG. 1. Additionally, or alternatively, encoders and decoders of first encoder-decoder architecture 200 may be trained using training data stored separately from memory 160.

As illustrated, an encoder-decoder architecture such as first encoder-decoder architecture 200 for image and/or position feature extraction may comprise one or more encoders (e.g., feature extractors 212, 222, spatial transformers 216, 226) that extract high-level features from the input data and one or more decoders (e.g., continuous convolution decoder 232) that reconstruct the input data from the learned features. This architecture may allow for the transformation of input data into compact and meaningful representations. The encoder-decoder architecture may enable the model to learn and utilize important visual and positional features, facilitating tasks like image generation, captioning, and translation.

Depth estimation unit 204 may, in some examples, use one or more encoders and/or one or more decoders to generate perspective view depth maps 206 based on 2D camera images 202. That is, depth estimation unit 204 may also be a CNN. Depth estimation unit 204 may use encoders and decoders to convert a 2D camera images 202 into perspective view depth maps 206. Depth estimation unit 204 may be part of a first encoder-decoder architecture 200 as a CNN that takes an input 2D camera images image of 2D camera images 202 and produces a corresponding perspective view depth map of perspective view depth maps 206. An encoder of depth estimation unit 204 may represent a front end of a CNN and may capture hierarchical features from the input 2D camera image. The encoder of depth estimation unit 204 may perform any one or more of convolutions, pooling operations, non-linear activations to reduce the spatial dimensions of the input 2D camera image while increasing a number of feature channels. The encoder of depth estimation unit 204 may extract abstract representations of the input 2D camera image that depth estimation unit 204 may use to determine depth information.

The output of an encoder of depth estimation unit 204 may represent a high-dimensional feature map that captures both low-level and high-level features of the input 2D camera image. This feature map may represent a latent space of the CNN and may encode information concerning a geometry and a texture of one or more objects within the 3D environment depicted in the input 2D camera images. Depth estimation unit 204 may include a decoder that represents a back end of the CNN and is responsible for converting a latent representation generated by the encoder into a depth map. The decoder of depth estimation unit 204 may accept a feature map from the encoder of depth estimation unit 204 and up-sample the feature map through a series of transposed convolutions. The decoder of depth estimation unit 204 may recover the spatial dimensions of the original image while reducing a number of feature channels.

Depth estimation unit 204 may, in some examples, improve a quality of depth predictions using skip connections. Skip connections may allow information from earlier encoder layers to be directly fed into corresponding decoder layers. Skip connections may preserve details and texture information that might have otherwise been lost during down-sampling by the encoder. A last layer of a decoder of depth estimation unit 204 may produce perspective view depth maps 206 as an output.

Processing system 100 may train a neural network of depth estimation unit 204 using training data 170 that includes pairs of 2D camera images and corresponding ground truth depth maps. Additionally, or alternatively, processing circuitry separate from processing system 100 may train a neural network of depth estimation unit 204 using training data that is stored separately from processing system 100 that includes pairs of 2D camera images and corresponding ground truth depth maps. During training, the neural network of depth estimation unit 204 may learn to predict perspective view depth maps 206 that correspond to input 2D camera images 202. The training process may involve minimizing a difference between the predicted perspective view depth maps 206 and the ground truth depth maps using a suitable loss function, such as mean squared error (MSE) or a variation that accounts for scale-invariant depth differences. Depth estimation unit 204 may use encoders to extract features from the input 2D camera image and decoders to convert these features into perspective view depth maps 206. The combination of encoders and decoders and the training process allows the neural network of depth estimation unit 204 to learn to estimate depth information.

First feature extractor 212 may represent an encoder of a neural network or another kind of model (e.g., BEV feature kernel unit 210) that is configured to extract information from input data and process the extracted information to generate an output. In general, encoders are configured to receive data as an input and extract one or more features from the input data. The features are the output from the encoder. The features may include one or more vectors of numerical data that can be processed by a machine learning model. These vectors of numerical data may represent the input data in a way that provides information concerning characteristics of the input data. In other words, encoders are configured to process input data to identify characteristics of the input data.

In some examples, the first feature extractor 212 represents a CNN, another kind of artificial neural network (ANN), or another kind of model that includes one or more layers and/or nodes. Each layer of the one or more layers may include one or more nodes. Examples of layers include input layers, output layers, and hidden layers between the input layers and the output layers. A CNN, for example, may include one or more convolutional layers comprising convolutional filters. Each convolutional filter may perform one or more mathematical operations on the input data to detect one or more features such as edges, shapes, textures, or objects. CNNs may additionally or alternatively include activation functions that identify complex relationships between elements of an image and pooling layers that recognize patterns regardless of location within the image frame.

First feature extractor 212 may generate first 3D features 214 based on perspective view depth maps 206. First 3D features 214 may provide information corresponding to one or more objects depicted in 2D camera images 202 and perspective view depth maps 206. For example, first 3D features 214 may include depth relationships between objects within the 3D environment, positions of objects within the 3D environment, a scene layout of the 3D environment, occlusion information indicating whether objects obscure each other (e.g., which objects are “in front” of other objects), sizes of one or more objects, an orientation and/or slope of surfaces of one or more objects, a texture of one or more objects, depth boundaries, parallax information, or any combination thereof. First 3D features 214 may include any one or combination of image features that indicate characteristics of objects within 2D camera images 202 and/or perspective view depth maps 206.

First spatial transformer 216 may represent a component of first encoder-decoder architecture 200 that is configured to perform one or more tasks involving spatial transformations. First spatial transformer 216 may include a spatial transformer network (STN) including localization and sampling generation modules that spatially transform input data. An STN such as first spatial transformer 216 may can perform geometric transformations on first 3D features 214 to improve an alignment of first 3D features 214 and/or or to adapt first 3D features 214 for specific tasks.

The first 3D features 214 features may include depth information extracted from the perspective view depth maps 206. The first 3D features 214 may represent a 3D structure of the 3D environment depicted in 2D camera images 202, with each feature corresponding to a particular point or region in the image. An encoder of first spatial transformer 216 may process the first 3D features 214 and convert first 3D features 214 into a more abstract representation. The encoder of first spatial transformer 216 may use convolutional layers to capture local patterns and structures in depth features of first 3D features 214. The output of the encoder of first spatial transformer 216 may represent a higher-level representation that encodes meaningful information about the 3D environment.

First spatial transformer 216 may include a localization network and a sampling generator. A localization network may accept the encoded first 3D features 214 from the encoder of first spatial transformer 216 as input generate parameters for performing spatial transformation. These parameters may include translation, rotation, scaling, and shearing values. The localization network may be implemented as a small neural network that produces transformation parameters based on the input features. The sampling generator uses the transformation parameters produced by the localization network to generate sampling. This sampling defines how the output data should be sampled from the input features. The sampling generator may account for transformation specified by the localization network, allowing the network to perform a geometric transformation of the input data. Sampling generated by the sampling generator may be used to sample 3D features from their original positions based on specified transformation parameters. This may result in a new representation of the features that have undergone spatial transformation. A transformed feature representation may be used for subsequent processing, such as feeding into another network for further analysis or task-specific processing.

3D point cloud frames 220 may be examples of 3D point cloud frames 166 of FIG. 1. In some examples, 3D point cloud frames 220 may represent a set of 3D point cloud frames from 3D point cloud frames 166 and 3D point cloud frames 166 may include one or more 3D point cloud frames that are not present in 3D point cloud frames 220. In some examples, first encoder-decoder architecture 200 processes 3D point cloud frames 220 in real time or near real time so that as LiDAR system 102 generates 3D point cloud frames 220, first encoder-decoder architecture 200 processes the captured 3D point cloud frames. In some examples, 3D point cloud frames 220 may represent collections of point coordinates within a 3D space (e.g., x, y, z coordinates within a Cartesian space) where LiDAR system 102 is located. Since LiDAR system 102 is configured to emit light signals and receive light signals reflected off surfaces of one or more objects, the collections of point coordinates may indicate a shape and a location of surfaces of the one or more objects within the 3D space.

Second feature extractor 222 may represent an encoder of a neural network or another kind of model that is configured to extract information from input data and process the extracted information to generate an output. Second feature extractor 222 may be substantially the same as first feature extractor 212 except that second feature extractor 222 extracts second 3D features 224 from 3D point cloud frames 220 collected by LiDAR system 102, whereas first feature extractor 212 extracts first 3D features 214 from perspective view depth maps 206 generated based on 2D camera images 202. That is, first feature extractor 212 and second feature extractor 222 may each extract features from 3D input data.

Second 3D features 224 may provide information corresponding to one or more objects indicated by 3D point cloud frames 220. For example, second 3D features 224 may include depth relationships between objects within the 3D environment, positions of objects within the 3D environment, a scene layout of the 3D environment, occlusion information indicating whether objects obscure each other (e.g., which objects are “in front” of other objects), sizes of one or more objects, an orientation and/or slope of surfaces of one or more objects, a texture of one or more objects, depth boundaries, parallax information, or any combination thereof. In some examples, first 3D features 214 may include at least some information that is not present in second 3D features 224 (e.g., color information, object identity information), and second 3D features 224 may include at least some information that is not present in first 3D features 214.

Second spatial transformer 226 may represent a component of first encoder-decoder architecture 200 that is configured to perform one or more tasks involving spatial transformations. Second spatial transformer 226 may include a spatial transformer network including localization and sampling generation modules that spatially transform input data. Second spatial transformer 226 may be substantially the same as first spatial transformer 216 except that second spatial transformer 226 performs geometric transformations on second 3D features 224, whereas first spatial transformer 216 performs geometric transformations on first 3D features 214.

Feature fusion unit 230 may be configured to fuse an output from first spatial transformer 216 and an output from the second spatial transformer 226 to generate a fused set of 3D features. The output from the first spatial transformer 216 may be based on the first 3D features 214 extracted by first feature extractor 212 based on image data. The output from the second spatial transformer 226 may be based on the second 3D features 224 extracted by second feature extractor 222 based on position data. In some examples, feature fusion unit 230 may use a concatenation operation to fuse the output from first spatial transformer 216 and the output from the second spatial transformer 226 to generate the set of 3D features. The concatenation operation may combine the output from first spatial transformer 216 and an output from the second spatial transformer 226 so that the fused set of 3D features includes useful information present in each of the first 3D features 214 and the second 3D features 224.

Continuous convolution decoder 232 may be configured to process the output from the feature fusion unit 230. In some examples, continuous convolution decoder 232 may represent a CNN, another kind of ANN, or another kind of model that includes one or more layers and/or nodes. Each layer of the one or more layers may include one or more nodes. Examples of layers include input layers, output layers, and hidden layers between the input layers and the output layers. In some examples, a decoder may include a series of transformation layers. Each transformation layer of the set of transformation layers may increase one or more spatial dimensions of the features, increase a complexity of the features, or increase a resolution of the features. A final layer of a decoder may generate a reconstructed output that includes an expanded representation of the features extracted by one or more encoders.

Continuous convolution decoder 232 may be configured to apply convolutional operations to a continuous signal, such as the output from feature fusion unit 230. In some examples, the output from the feature fusion unit 230 may be in a continuous space since both of first 3D features 214 and second 3D features 224 are 3D as opposed to one or both of first 3D features 214 and second 3D features 224 being 2D. Convolution may, in some cases, be used in the context of discrete signals (e.g., camera images), where convolution involves sliding a filter over a discrete grid of pixels. In some examples, convolution can be defined and applied to continuous functions as well. For example, continuous convolution decoder 232 may apply continuous convolution to the fused set of 3D features. By using depth estimation unit 204 to generate perspective view depth maps 206 based on 2D camera images 202, first encoder-decoder architecture 200 may allow continuous convolution decoder 232 to process features extracted from both image data and position data using continuous convolution without relying on 2D grids of features.

In some examples, continuous convolution decoder 232 may apply one or more continuous functions. Applying continuous functions may involve applying a kernel function. A kernel function may represent a continuous version of functions used for discrete convolution. A kernel function may indicate an influence of nearby points on an output value at a particular location. To apply a kernel function, continuous convolution decoder 232 may slide a kernel over the output from feature fusion unit 230. At each position, when a kernel is centered at a specific location, an overlap between the kernel and the data may be used to compute a weighted sum. At each position, the values of the input data covered by the kernel may be multiplied by corresponding values of the kernel function. Continuous convolution decoder 232 may sum these products to produce an output value at that position. A result of applying a kernel function may be a new continuous function, referred to as a “convolved function.” The kernel function applied by continuous convolution decoder 232 may be separate from BEV feature kernels 236 output from flattening unit 234.

Flattening unit 234 may transform the 3D output from continuous convolution decoder 232 into BEV feature kernels 236. Flattening unit 234 may compress 3D features into 2D BEV features of BEV feature kernels 236. In some examples, each BEV feature kernel of BEV feature kernels 236 may correspond to a region, an object, a set of objects, or another portion of a 3D environment. BEV feature kernels 236 may indicate characteristics of the 3D environment from a position above one or more objects within the 3D environment looking down at the one or more objects within the 3D environment.

In some examples, first encoder-decoder architecture 200 may apply a segmentation kernel fusion decoder to generate BEV feature kernels 236 based on the output from flattening unit 234. BEV feature kernels 236 may, in some examples, represent grid-free learnable Gaussian mixture model (GMM) kernels. A GMM is a probabilistic model that represents a mixture of several Gaussian distributions. A GMM may be used for clustering and density estimation tasks, for example when processing data that might be generated from multiple underlying sources such as camera images and point cloud frames. In the context of processing features extracted from camera images and point cloud frames, GMMs may be applied for tasks such as object recognition, segmentation, anomaly detection, and more.

Before applying a GMM, first encoder-decoder architecture 200 may extract relevant features from 2D camera images 202 and 3D point cloud frames 220. In the case of 2D camera images 202, extracted features may include color histograms, texture descriptors, edge features, deep learning embeddings, depth features indicated by perspective view depth maps 206 generated from 2D camera images 202, or any combination thereof. For 3D point cloud frames 220, extracted features may include spatial coordinates, normals, surface descriptors, or any combination thereof. Once the features are extracted, first encoder-decoder architecture 200 may create a dataset where each data point corresponds to a set of extracted features. This dataset is then used as input for the GMM algorithm.

First encoder-decoder architecture 200 may be configured to generate an output 240 based on the BEV feature kernels 236. The output 240 may comprise a 2D BEV representation of the 3D environment corresponding to processing system 100. For example, when processing system 100 is part of an ADAS for controlling a vehicle, the output 240 may indicate a BEV view of one or more roads, road signs, road markers, traffic lights, vehicles, pedestrians, and other objects within the 3D environment corresponding to processing system 100. This may allow processing system 100 to use the output 240 to control the vehicle within the 3D environment.

Since the output 240 includes a bird's eye view of one or more objects that are in a 3D environment corresponding to first encoder-decoder architecture 200, a control unit (e.g., control unit 142 and/or control unit 196 of FIG. 1) may use the output 240 to control a device (e.g., a vehicle, one or more robotic components) within the 3D environment. For example, when the output 240 indicates a vehicle ahead of a vehicle corresponding to processing system 100, the control unit may control the vehicle to change lanes to pass the other vehicle. In another example, when the output 240 indicates a stop sign ahead, the control unit may control the vehicle to stop at an intersection.

It may be beneficial for first encoder-decoder architecture 200 to transform 2D camera images 202 from a 2D grid of pixels into a 3D representation of the 3D environment corresponding to processing system 100 so that first encoder-decoder architecture 200 may process both features extracted from image data and features extracted from position data in a continuous space. This is because using continuous convolution to process image data features and position data features allows BEV feature kernel unit 210 to generate BEV feature kernels 236 without relying on 2D grids of BEV feature cells. In some examples, using 2D grids of BEV feature cells may cause features corresponding to different objects to be crammed into the same cell, which causes blurring. That is, information important for generating an output based on BEV features may be lost when a system relies on 2D grids of BEV features. Using continuous convolution to generate BEV feature kernels 236 may ensure that BEV feature kernels 236 includes the most important information for generating an output.

First encoder-decoder architecture 200 may, in some examples, automatically train based on using 3D point cloud frames 220 as a ground truth to be compared to the output 240. For example, ground truth unit 242 may generate kernelized ground truth 246 based on 3D point cloud frames 220. First encoder-decoder architecture 200 may compare the kernelized ground truth 246 with the output 240. Based on the comparison between the kernelized ground truth 246 with the output 240, first encoder-decoder architecture 200 may train or re-train one or more components of first encoder-decoder architecture 200. For example, first encoder-decoder architecture 200 may train one or more encoders or decoders of first encoder-decoder architecture 200.

In some examples, ground truth unit 242 generates kernelized ground truth 246 by aggregating semantic point cloud frames. To generate kernelized ground truth 246, ground truth unit 242 may select spheres in one or more point cloud frames and test each point one or more times using different sphere locations. For each sphere, ground truth unit 242 may select a sphere center and evaluate contribution weights of a per-class Gaussian function. In some examples, to compare the kernelized ground truth 246 with the output 240, first encoder-decoder architecture 200 may determine a distributional loss corresponding to the kernelized ground truth 246 and the output 240. The distributional loss may be referred to as a “GMM” parametric loss.”

To determine the distributional loss, first encoder-decoder architecture 200 may determine a distance between set of 2D continuous GMM distributions. For example, kernelized ground truth 246 and the output 240 may each include a set of 2D continuous GMM distributions. First encoder-decoder architecture 200 may determine a difference between each 2D continuous GMM distribution corresponding to output 240 and a corresponding 2D continuous distribution of the kernelized ground truth 246. In some examples, first encoder-decoder architecture 200 may determine a Kullback-Leibler (KL) divergence loss corresponding to the kernelized ground truth 246 and the output 240. A loss may correspond to a distance between a set of ground truth mixture models and prediction mixture models centered around continuous 2D coordinates. Comparing kernelized ground truth 246 and the output 240 may improve sensitivity to continuous features and robustness of continuous class boundaries as compared with systems that do not compare an output of an encoder-decoder architecture with ground truth.

First encoder-decoder architecture 200 may represent BEV features and ground truth in grid-free representations that depend on a resolution of a ground truth without depending on a resolution of a fixed BEV feature grid. Segmentation in BEV features may be sensitive to small, narrow, and thin objects such as traffic lights, traffic signs, lane markers, and curbs. The system can be used to reduce memory consumption in BEV pooling and BEV feature extraction by reducing a number of parameters and an amount of memory consumption as compared with systems that rely on fixed BEV feature grids.

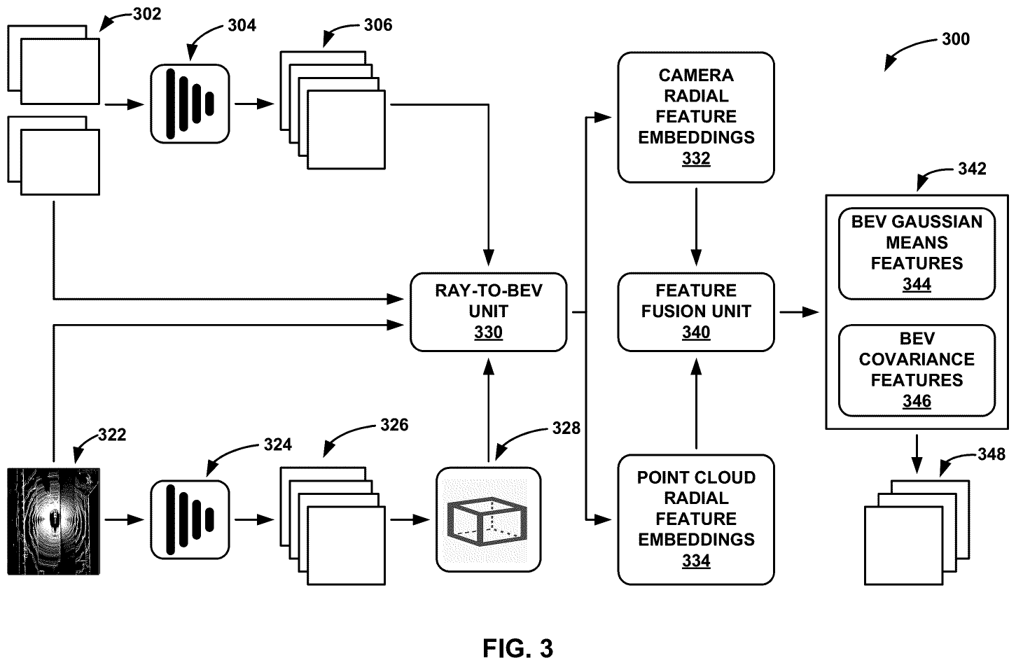

FIG. 3 is a block diagram illustrating a second encoder-decoder architecture 300 for processing image data and position data in a continuous space to generate an output, in accordance with one to more techniques of this disclosure. In some examples, second encoder-decoder architecture 300 may be a part of continuous BEV unit 140 and/or continuous BEV unit 194 of FIG. 1. FIG. 3 illustrates 2D camera images 302, first feature extractor 304, perspective view features 306, 3D point cloud frames 322, second feature extractor 324, 3D features 326, and flattening unit 328. FIG. 3 also illustrates Ray-to-BEV unit 330, camera radial feature embeddings 332, point cloud radial feature embeddings 334, feature fusion unit 340, fused BEV features 342, and BEV feature kernels 348.

2D camera images 302 may be examples of 2D camera images 168 of FIG. 1. In some examples, 2D camera images 302 may represent a set of camera images from 2D camera images 168 and 2D camera images 168 may include one or more camera images that are not present in 2D camera images 202. In some examples, 2D camera images 302 may be received from a plurality of cameras at different locations and/or different fields of view, which may be overlapping. In some examples, second encoder-decoder architecture 300 processes 2D camera images 302 in real time or near real time so that as camera(s) 104 captures 2D camera images 302, second encoder-decoder architecture 300 processes the captured camera images. In some examples, 2D camera images 302 may represent one or more perspective views of one or more objects within a 3D space where processing system 100 is located. That is, the one or more perspective views may represent views from the perspective of processing system 100.

In some examples, second encoder-decoder architecture 300 may be configured to convert the set of 2D camera images 302 into a first 3D representation of a 3D environment corresponding to 2D camera images 302 and 3D point cloud frames 322. 3D point cloud frames 322 may represent a second 3D representation of the 3D environment. In this way, second encoder-decoder architecture 300 may cause both 2D camera images 302 and the 3D point cloud frames 322 to be a 3D representation of the 3D environment. This may allow second encoder-decoder architecture 300 to process features extracted from 2D camera images 302 and the 3D point cloud frames 322 in a continuous space without using discrete processing that relies on 2D grids of features. For example, second encoder-decoder architecture 300 may generate a set of BEV features. Although the set of BEV features may include a 2D representation of the 3D environment, the set of BEV features might not rely on a 2D grid of BEV feature cells that place features corresponding to many different objects in the same cell.

First feature extractor 304 may represent an encoder of a neural network or another kind of model that is configured to extract information from input data and process the extracted information to generate an output. In some examples, the first feature extractor 304 represents a CNN, another kind of ANN, or another kind of model that includes one or more layers and/or nodes. Each layer of the one or more layers may include one or more nodes. Examples of layers include input layers, output layers, and hidden layers between the input layers and the output layers. A CNN, for example, may include one or more convolutional layers comprising convolutional filters. Each convolutional filter may perform one or more mathematical operations on the input data to detect one or more features such as edges, shapes, textures, or objects. CNNs may additionally or alternatively include activation functions that identify complex relationships between elements of an image and pooling layers that recognize patterns regardless of location within the image frame.

First feature extractor 304 may extract, from 2D camera images 302, perspective view features 306. Perspective view features 306 may provide information corresponding to one or more objects depicted in 2D camera images 302 from the perspective of camera(s) 104 which captures 2D camera images 302. For example, perspective view features 306 may include vanishing points and vanishing lines that indicate a point at which parallel lines converge or disappear, a direction of dominant lines, a structure or orientation of objects, or any combination thereof. Perspective view features 306 may include color information. Additionally, or alternatively, perspective view features 306 may include key points that are matched across a group of two or more camera images of 2D camera images 302. Key points may allow second encoder-decoder architecture 300 to determine one or more characteristics of motion and pose of objects. Perspective view features 306 may include any one or combination of image features that indicate characteristics of 2D camera images 302.

In some examples, perspective view features 306 may represent 2D features. That is, perspective view features 306 may indicate characteristics of one or more objects within the 3D environment corresponding to 2D camera images 302 and 3D point cloud frames 322 corresponding to locations on a 2D camera image from a perspective of camera(s) 104. One technique for converting perspective view features 306 into BEV features is to project perspective view features 306 onto a 2D grid of BEV cells. This may involve discrete processing that places features corresponding to many different objects into the same cell, which causes blurring and poor resolution. Second encoder-decoder architecture 300 may convert the perspective view features 306 into a 3D representation of the 3D environment so that encoder-decoder architecture 300 is configured to use continuous processing to generate BEV features instead of using discrete processing.

3D point cloud frames 322 may be examples of 3D point cloud frames 166 of FIG. 1. In some examples, 3D point cloud frames 322 may represent a set of 3D point cloud frames from 3D point cloud frames 166 and 3D point cloud frames 166 may include one or more 3D point cloud frames that are not present in 3D point cloud frames 322. In some examples, second encoder-decoder architecture 300 processes 3D point cloud frames 322 in real time or near real time so that as LiDAR system 102 generates 3D point cloud frames 322, second encoder-decoder architecture 300 processes the captured 3D point cloud frames. In some examples, 3D point cloud frames 322 may represent collections of point coordinates within a 3D space (e.g., x, y, z coordinates within a Cartesian space) where LiDAR system 102 is located. Since LiDAR system 102 is configured to emit light signals and receive light signals reflected off surfaces of one or more objects, the collections of point coordinates may indicate a shape and a location of surfaces of the one or more objects within the 3D space.

Second feature extractor 324 may represent an encoder of a neural network or another kind of model that is configured to extract information from input data and process the extracted information to generate an output. Second feature extractor 324 may be similar to first feature extractor 304 in that both the first feature extractor 304 and the second feature extractor 324 are configured to process input data to generate output features. But in some examples, first feature extractor 304 is configured to process 2D input data and second feature extractor 324 is configured to process 3D input data. In some examples, processing system 100 is configured to train first feature extractor 304 using a set of training data of training data 170 that includes one or more training camera images and processing system 100 is configured to train second feature extractor 324 using a set of training data of training data 170 that includes one or more point cloud frames. That is, processing system 100 may train first feature extractor 304 to recognize one or more patterns in camera images that correspond to certain camera image perspective view features and processing system 100 may train second feature extractor 324 to recognize one or more patterns in point cloud frames that correspond to certain 3D sparse features. In some examples, processing circuitry separate from processing system 100 is configured to train one or more elements of second encoder-decoder architecture 300 using training data stored separately from processing system 100.

Second feature extractor 324 may generate a set of 3D features 326 based on 3D point cloud frames 322. 3D features 326 may provide information corresponding to one or more objects indicated by 3D point cloud frames 322 within a 3D space that includes LiDAR system 102 which captures 3D point cloud frames 322. 3D features 326 may include key points within 3D point cloud frames 322 that indicate unique characteristics of the one or more objects. For example, key points may include corners, straight edges, curved edges, peaks of curved edges. Second encoder-decoder architecture 300 may recognize one or more objects based on key points. 3D features 326 may additionally or alternatively include descriptors that allow second feature extractor 324 to compare and track key points across groups of two or more point cloud frames of 3D point cloud frames 322. Other kids of 3D features 326 include voxels and super pixels.

Flattening unit 328 may transform 3D features 326 into 2D features. Since 3D point cloud frames 322 represent multi-dimensional arrays of cartesian coordinates, flattening unit 328 may transform 3D features 326 into 2D features by compressing one of the dimensions of the x, y, z cartesian space into a flattened plane without compressing the other two dimensions. That is, the points within a column of points parallel to one of the dimensions of the x, y, z cartesian space may be compressed into a single point on a 2D space formed by the two dimensions that are not compressed. Perspective view features 306 extracted from 2D camera images 302, on the other hand, might not include cartesian coordinates. This means that it may be beneficial to transform perspective view features 306 into a 3D representation of the 3D environment so that both of features extracted from image data and features extracted from position data can be processed in a continuous space without using discrete processing that relies on 2D grids of BEV cells.

Ray-to-BEV unit 330 may receive perspective view features 306 extracted from 2D camera images 302. Ray-to-BEV unit 330 may receive the output from flattening unit 328 which represents flattened 3D features 326 extracted from 3D point cloud frames 322. Ray-to-BEV unit 330 may receive 2D camera images 302 and 3D point cloud frames 322. Based on any one or combination of perspective view features 306, the output from flattening unit 328, 2D camera images 302, and 3D point cloud frames 322, ray-to-BEV unit 330 may generate camera radial feature embeddings 332 and point cloud radial feature embeddings 334.

In some examples, ray-to-BEV unit 330 may generate camera radial feature embeddings 332 by converting perspective view features 306 and 2D camera images 302 into a 3D representation of the 3D environment corresponding to 2D camera images 302 and 3D point cloud frames 322. For example, ray-to-BEV unit 330 may create, based on each camera image pixel of 2D camera images 302, a ray through a 3D space. Ray-to-BEV unit 330 may identify, for the ray corresponding to each camera image pixel of 2D camera images 302, one or more points within the 3D space. Ray-to-BEV unit 330 may create, for the one or more points of each ray corresponding to 2D camera images 302, a depth distribution. Ray-to-BEV unit 330 may generate a 3D feature volume based on the 3D space and the depth distribution of each ray corresponding to 2D camera images 302. The 3D feature volume may represent a 3D representation of the 3D environment corresponding to 2D camera images 302 and 3D point cloud frames 322. In some examples, ray-to-BEV unit 330 may generate point cloud radial feature embeddings 334 based on 3D point cloud frames 322 and 3D features 326 extracted from 3D point cloud frames 322.

Feature fusion unit 340 may, in some examples, fuse the camera radial feature embeddings 332 and the point cloud radial feature embeddings 334 to generate fused BEV features 342. In some examples, fused BEV features 342 may include BEV Gaussian means features 344 and BEV covariance features 346. In some examples, feature fusion unit 340 may use a concatenation operation to fuse the camera radial feature embeddings 332 and point cloud radial feature embeddings 334 to generate fused BEV features 342. The concatenation operation may combine camera radial feature embeddings 332 and point cloud radial feature embeddings 334 so that the fused set of 3D features includes useful information present in each of the camera radial feature embeddings 332 and point cloud radial feature embeddings 334.

BEV Gaussian means features 344 may include central values or averages of a Gaussian distribution. A Gaussian distribution may be defined by two or more parameters including a mean (μ) and a standard deviation (σ). The mean represents the center of the distribution, around which data points may be clustered. BEV Gaussian means features 344 may represent different means of multiple Gaussian distributions. In some examples, especially in mixture models, each Gaussian component might represent a different cluster or mode of the data. The means of these components can be considered as features that capture the central tendencies of each cluster. These features may be used for tasks such as clustering, identifying data points that are similar based on their proximity to Gaussian means.

BEV covariance features 346 may indicate relationships between different variables within a multivariate Gaussian distribution. A covariance between two variables may indicate how much the variables vary together. A positive covariance may indicate that that when a first variable increases, a second variable increases, and when the first variable decreases, the second variable decreases. A negative covariance may correspond to an inverse relationship. For example, a negative covariance may indicate that that when a first variable increases, a second variable decreases, and when the first variable decreases, the second variable increases. Covariance values may be used to understand patterns and relationships among variables. For example, covariance features may be useful in applications like principal component analysis (PCA) to identify the most important dimensions that capture variance in data.

Second encoder-decoder architecture 300 may generate BEV feature kernels 348 based on fused BEV features 342. In some examples, each BEV feature kernel of BEV feature kernels 348 may correspond to a region, an object, a set of objects, or another portion of a 3D environment. BEV feature kernels 348 may indicate characteristics of the 3D environment from a position above one or more objects within the 3D environment looking down at the one or more objects within the 3D environment. In some examples, second encoder-decoder architecture 300 may generate an output based on BEV feature kernels 348.

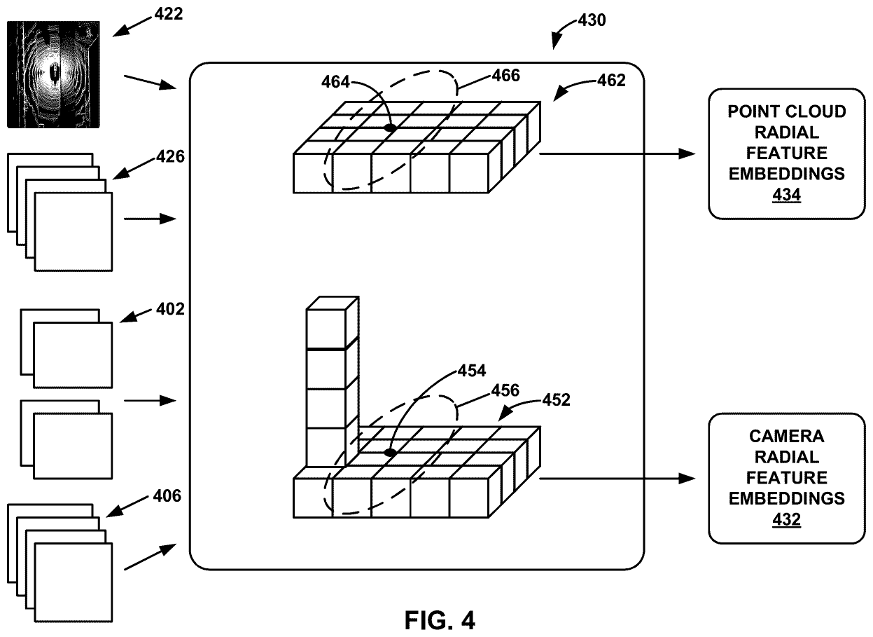

FIG. 4 is a conceptual diagram illustrating an example ray-to-BEV unit 430, in accordance with one or more techniques of this disclosure. As seen in FIG. 4, ray-to-BEV unit 430 is configured to receive 2D camera images 402, perspective view features 406, 3D point cloud frames 422, and 3D features 426 as inputs. Ray-to-BEV unit 430 may be configured to generate camera radial feature embeddings 432 and point cloud radial features. Ray-to-BEV unit 430 includes first 3D space 452, a first reference point 454, a first spatial neighborhood 456, a second 3D space 462, a second reference point 464, and a second spatial neighborhood 466.

2D camera images 402 may be examples of 2D camera images 302 of FIG. 3. Perspective view features 406 may be examples of perspective view features 306 of FIG. 3. 3D point cloud frames 422 may be examples of 3D point cloud frames 322 of FIG. 3. 3D features 426 may be examples of 3D features 326 of FIG. 3. Ray-to-BEV unit 430 may be an example of ray-to-BEV unit 330 of FIG. 3. Camera radial feature embeddings 432 may be examples of camera radial feature embeddings 332 of FIG. 3. Point cloud radial feature embeddings 434 may be examples of point cloud radial feature embeddings 334 of FIG. 3.

Ray-to-BEV unit 430 may build kernelized continuous representation of feature maps in a BEV space by using a splatting point cloud representation from camera pixel-ray context representation in local self similarity (LSS). To generate precise depth-to-center feature embeddings, ray-to-BEV unit 430 may use a 3D reference point from LiDAR point clouds and examine a spherical neighborhood around the reference point to learn a multivariate Gaussian mixture with mean/covariance estimates. Perspective view features regions corresponding to the 3D reference point and their respective rays may be used to evaluate variational autoencoder (VAE) parameters and/or GMM parameters.

Ray-to-BEV unit 430 may generate first 3D space 452 based on 2D camera images 402. In some examples, ray-to-BEV unit 430 may generate first 3D space 452 by generating a ray corresponding to each pixel of 2D camera images 402. The ray corresponding to each pixel of 2D camera images 402 may include a set of points. In some examples, ray-to-BEV unit 430 may generate camera radial feature embeddings 432. By generating the first 3D space 452 based on 2D camera images 402, ray-to-BEV unit 430 may convert 2D camera images 402 into a 3D representation of the 3D environment corresponding to 2D camera images 402 and 3D point cloud frames 422. Converting 2D camera images 402 into the 3D representation of the 3D environment may allow ray-to-BEV unit 430 to generate camera radial feature embeddings 432 in a way that does not rely on fixed grids of BEV features.

Ray-to-BEV unit 430 may, in some examples, generate camera radial feature embeddings 432 by populating the first 3D space with perspective view features of perspective view features 406. For example, ray-to-BEV unit 430 may select first reference point 454 based on 3D point cloud frames 422 and populate first spatial neighborhood 456 with perspective view features of perspective view features 406 corresponding to the first reference point 454. In some examples, first reference point 454 may be one reference point of a set of reference points corresponding to first 3D space 452. Ray-to-BEV unit 430 may populate a spatial neighborhood corresponding to each reference point with perspective view features in the spatial neighborhood of the reference point.

In some examples, second 3D space 462 corresponds to a 3D space of 3D point cloud frames 422. Since 3D point cloud frames 422 includes points having 3D coordinates, 3D point cloud frames 422 may already represent a 3D space without needing conversion to 3D. Ray-to-BEV unit 430 may populate second 3D space 462 with 3D features of 3D features 426. For example, ray-to-BEV unit 430 may select second reference point 464 based on 3D point cloud frames 422 and populate second spatial neighborhood 466 with 3D features of 3D features 426 corresponding to second spatial neighborhood 466. In some examples, second reference point 464 represents one reference point of a set of reference points corresponding to second 3D space 462. Ray-to-BEV unit 430 may populate a spatial neighborhood corresponding to each reference point with respective 3D features of 3D features 426.

Ray-to-BEV unit 430 may use radial neighborhood feature selection to generate camera radial feature embeddings 432 and point cloud radial feature embeddings 334. Camera BEV features may be “splatted” onto a point cloud, transformed using a neighbor centered on a LiDAR point cloud. BEV features may be continuously embedded using VAE GMMs. Ray-to-BEV unit 430 may convert the point cloud representation from camera perspective features into continuous BEV features.

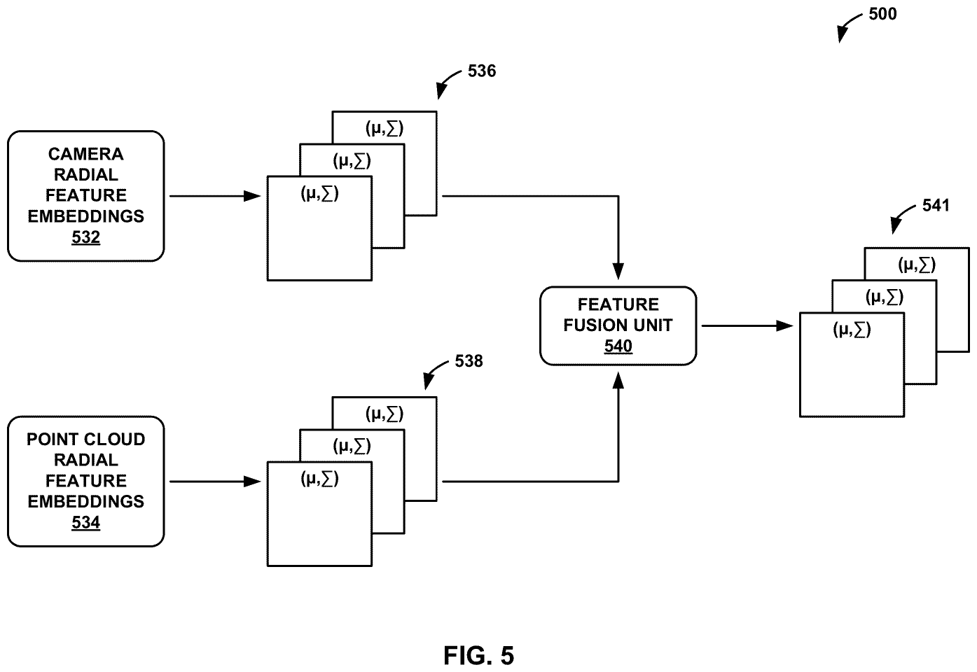

FIG. 5 is a conceptual diagram illustrating a system 500 for using an example feature fusion unit 540 to generate fused grid-free BEV feature kernels 541, in accordance with one or more techniques of this disclosure. As seen in FIG. 5, system 500 includes camera radial feature embeddings 532, point cloud radial feature embeddings 534, camera grid-free BEV feature kernels 536, point cloud grid-free BEV feature kernels 538, feature fusion unit 540, and fused grid-free BEV feature kernels 541. System 500 may be a part of second encoder-decoder architecture 300 of FIG. 3. Camera radial feature embeddings 532 may be examples of camera radial feature embeddings 332 of FIG. 3. Point cloud radial feature embeddings 534 may represent point cloud radial feature embeddings 334 of FIG. 3. Feature fusion unit 540 may be an example of feature fusion unit 340 of FIG. 3.

System 500 may generate camera grid-free BEV feature kernels 536 based on camera radial feature embeddings 532. In some examples, the camera radial feature embeddings 532 may be generated based on a 3D representation of a 3D environment. This means that system 500 may be configured to generate camera grid-free BEV feature kernels 536 in a continuous space without relying on 2D grids of BEV features. System 500 may generate point cloud grid-free BEV feature kernels 538 based on point cloud radial feature embeddings 534. In some examples, the point cloud radial feature embeddings 534 may be generated based on a 3D representation of a 3D environment. This means that system 500 may be configured to generate point cloud grid-free BEV feature kernels 538 in a continuous space without relying on 2D grids of BEV features.

Camera grid-free BEV feature kernels 536 and point cloud grid-free BEV feature kernels 538 may represent VAE-GMM kernels. VAE-GMM kernels may include a VAE component and a GMM component. The VAE component may map input data to a probabilistic distribution in a latent space and include data samples from points in the latent space. The GMM component may represent a mixture of multiple Gaussian distributions that may be used for clustering, density estimation, and generative modeling.

Feature fusion unit 540 may fuse camera grid-free BEV feature kernels 536 and point cloud grid-free BEV feature kernels 538 to generate fused grid-free BEV feature kernels 541. Since both camera grid-free BEV feature kernels 536 and point cloud grid-free BEV feature kernels 538 do not rely on fixed grids of BEV features, feature fusion unit 540 may fuse camera grid-free BEV feature kernels 536 and point cloud grid-free BEV feature kernels 538 without relying on discrete processing. Fused grid-free BEV feature kernels 541 may include a set of kernels each including BEV Gaussian means features of BEV Gaussian means features 344 and BEV covariance features of BEV covariance features 346.

System 500 may use a GMM to fit the camera radial feature embeddings 532 and the point cloud radial feature embeddings 534 to continuous space 2D coordinates (e.g., camera grid-free BEV feature kernels 536 and point cloud grid-free BEV feature kernels 538) centered on reference points from 3D point cloud frames 166 of FIG. 1. Camera grid-free BEV feature kernels 536 and point cloud grid-free BEV feature kernels 538 may represent continuous GMM features from camera and LiDAR data respectively. Feature fusion unit 540 may combine camera grid-free BEV feature kernels 536 and point cloud grid-free BEV feature kernels 538 by re-estimating a unified grid free representation by combining the GMM estimates via resampling. Ground truth discretization may be avoided by using kernelized continuous representation of segmentation by centering around a reference point in a 3D point cloud frame of 3D point cloud frames 166. The BEV features, ground truth, and BEV output prediction may thus be represented as a 2D BEV mixture model avoiding discretization artifacts.

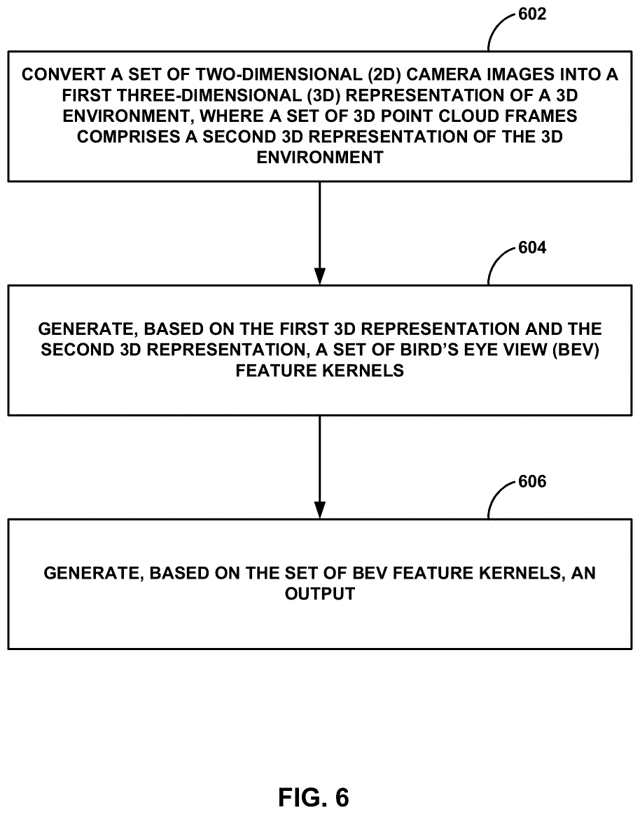

FIG. 6 is a flow diagram illustrating an example method for generating BEV features based on converting image data into a 3D representation of a 3D environment, in accordance with one or more techniques of this disclosure. FIG. 6 is described with respect to processing system 100 and external processing system 180 of FIG. 1, first encoder-decoder architecture 200 of FIG. 2, and second encoder-decoder architecture 300 of FIG. 3. However, the techniques of FIG. 6 may be performed by different components of processing system 100, external processing system 180, first encoder-decoder architecture 200, and second encoder-decoder architecture 300, or by additional or alternative systems.

Continuous BEV unit 140 may convert 2D camera images 168 into a first 3D representation of a 3D environment, where 3D point cloud frames 166 comprises a second 3D representation of the 3D environment (602). For example, first encoder-decoder architecture 200 may use depth estimation unit 204 to generate perspective view depth maps 206 based on 2D camera images 206. Additionally, or alternatively, ray-to-BEV unit 330 of second encoder-decoder architecture 300 may populate a 3D space generated based on 2D camera images 302 with perspective view features 306.

Continuous BEV unit 140 may generate, based on the first 3D representation and the second 3D representation, a set of BEV feature kernels, where the set of BEV features comprises a 2D representation of the 3D environment (604). For example, continuous convolution decoder 232 may process an output from first spatial transformer 216 and an output from second spatial transformer 226 using continuous convolution to generate BEV feature kernels 236. Additionally, or alternatively, feature fusion unit 340 may generate fused BEV features 342 and BEV feature kernels 348 based on camera radial feature embeddings 332 and point cloud radial feature embeddings 334. Continuous BEV unit 140 may generate an output based on the set of BEV feature kernels (606).

Additional aspects of the disclosure are detailed in numbered clauses below.

Clause 1—An apparatus for processing image data and position data includes a memory for storing the image data and the position data, wherein the image data comprises a set of 2D camera images, and wherein the position data comprises a set of 3D point cloud frames. The apparatus also includes processing circuitry in communication with the memory, wherein the processing circuitry is configured to convert the set of 2D camera images into a first 3D representation of a 3D environment corresponding to the image data and the position data, wherein the set of 3D point cloud frames comprises a second 3D representation of the 3D environment. The processing circuitry is also configured to generate, based on the first 3D representation and the second 3D representation, a set of BEV feature kernels in a continuous space and generate, based on the set of BEV feature kernels, an output.

Clause 2—The system of Clause 1, wherein the processing circuitry is configured to generate the set of BEV feature kernels without relying on a BEV feature grid that includes a set of BEV feature cells each having a fixed dimension.

Clause 3—The system of any of Clauses 1-2, wherein to convert the set of 2D camera images into the first 3D representation of the 3D environment, the processing circuitry is configured to apply a depth estimation unit to generate, based on the image data, a set of perspective view depth maps comprising the first 3D representation of the 3D environment corresponding to the image data.

Clause 4—The system of Clause 3, wherein the depth estimation unit comprises one or more encoders and one or more decoders, and wherein to apply the depth estimation unit to generate the set of perspective view depth maps, the processing circuitry is configured to apply the one or more encoders and one or more decoders to generate the set of perspective view depth maps to indicate a location of one or more objects indicated by the image data within the 3D environment.

Clause 5—The system of any of Clauses 1-4, wherein the first 3D representation of the 3D environment comprises a set of perspective view depth maps generated based on the image data, and wherein to generate the set of BEV feature kernels, the processing circuitry is configured to: apply a first feature extractor to extract, from the set of perspective view depth maps, a first set of 3D features; apply a second feature extractor to extract, from the set of 3D point cloud frames, a second set of 3D features; and generate, based on the first set of 3D features and the second set of 3D features, the set of BEV feature kernels.

Clause 6—The system of Clause 5, wherein to generate the set of BEV feature kernels, the processing circuitry is configured to: fuse the first set of 3D features and the second set of 3D features to generate a fused set of 3D features; apply, to the fused set of 3D features, a continuous convolution decoder to generate a processed fused set of 3D features; and compress the processed fused set of 3D features to generate the set of BEV feature kernels.

Clause 7—The system of any of Clauses 1-6, wherein to convert the set of 2D camera images into the first 3D representation of the 3D environment, the processing circuitry is configured to: apply a feature extractor to extract, from the set of camera images, a set of perspective view features; generate, based on the set of 2D camera images, a 3D feature volume; and populate the 3D feature volume with the set of perspective view features to create a populated 3D feature volume.

Clause 8—The system of Clause 7, wherein to generate the 3D feature volume, the processing circuitry is configured to: create, based on each camera image pixel of the set of 2D camera images, a ray through a 3D space; identify, for the ray corresponding to each camera image pixel of the set of 2D camera images, one or more points within the 3D space; create, for the one or more points of each ray corresponding to the set of 2D camera images, a depth distribution; and generate the 3D feature volume based on the 3D space and the depth distribution of each ray corresponding to the set of 2D camera images.

Clause 9—The system of any of Clauses 7-8, wherein the feature extractor is a first feature extractor, wherein the populated 3D feature volume is a first 3D feature volume, and wherein to generate the set of BEV feature kernels, the processing circuitry is configured to: apply a second feature extractor to extract, from the set of 3D point cloud frames, a second 3D feature volume; compress the first 3D feature volume to generate a set of image data BEV feature kernels; compress the second 3D feature volume to generate a set of position data BEV feature kernels; and fuse the set of image data BEV feature kernels and the set of position data BEV feature kernels to generate the set of BEV feature kernels.

Clause 10—The system of any of Clauses 1-9, wherein to generate the output, the processing circuitry is configured to: generate, based on the set of BEV feature kernels, the output to include a BEV representation of one or more objects within the 3D environment, and wherein the processing circuitry is further configured to use the output to control a device within the 3D environment based on the one or more objects within the 3D environment.

Clause 11—The system of any of Clauses 1-10, wherein the processing circuitry is configured to: apply an encoder-decoder architecture to generate the set of BEV feature kernels; generate, based on the position data, kernelized ground truth corresponding to the output; compare the kernelized ground truth with the output; and train the encoder-decoder architecture automatically based on comparing the kernelized ground truth with the output.

Clause 12—The system of any of Clauses 1-11, wherein the processing circuitry and the memory are part of an ADAS.

Clause 13—The system of any of Clauses 1-12, wherein the processing circuitry is configured to use the output to control a vehicle.

Clause 14—The system of any of Clauses 1-13, wherein the apparatus further comprises: one or more cameras configured to capture the set of 2D camera images; and a LiDAR system configured to capture the set of 3D point cloud frames.

Clause 15—A method includes converting a set of 2D camera images into a first 3D representation of a 3D environment corresponding to image data and position data, wherein a set of 3D point cloud frames comprises a second 3D representation of the 3D environment, wherein a memory is configured to store the image data and the position data, wherein the image data comprises the set of 2D camera images, and wherein the position data comprises the set of 3D point cloud frames. The method also includes generating, based on the first 3D representation and the second 3D representation, a set of BEV feature kernels in a continuous space and generating, based on the set of BEV feature kernels, an output.

Clause 16—The method of clause 15, further comprising generating the set of BEV feature kernels without relying on a BEV feature grid that includes a set of BEV feature cells each having a fixed dimension.

Clause 17—The method of any of clauses 15-16, wherein converting the set of 2D camera images into the first 3D representation of the 3D environment comprises applying a depth estimation unit to generate, based on the image data, a set of perspective view depth maps comprising the first 3D representation of the 3D environment corresponding to the image data.

Clause 18—The method of clause 17, wherein the depth estimation unit comprises one or more encoders and one or more decoders, and wherein applying the depth estimation unit to generate the set of perspective view depth maps comprises applying the one or more encoders and one or more decoders to generate the set of perspective view depth maps to indicate a location of one or more objects indicated by the image data within the 3D environment.

Clause 19—The method of any of clauses 15-18, wherein the first 3D representation of the 3D environment comprises a set of perspective view depth maps generated based on the image data, and wherein generating the set of BEV feature kernels comprises: applying a first feature extractor to extract, from the set of perspective view depth maps, a first set of 3D features; applying a second feature extractor to extract, from the set of 3D point cloud frames, a second set of 3D features; and generating, based on the first set of 3D features and the second set of 3D features, the set of BEV feature kernels.

Clause 20—The method of clause 19, wherein generating the set of BEV feature kernels comprises: fusing the first set of 3D features and the second set of 3D features to generate a fused set of 3D features; applying, to the fused set of 3D features, a continuous convolution decoder to generate a processed fused set of 3D features; and compressing the processed fused set of 3D features to generate the set of BEV feature kernels.

Clause 21—The method of any of clauses 15-20, wherein converting the set of 2D camera images into the first 3D representation of the 3D environment comprises: applying a feature extractor to extract, from the set of camera images, a set of perspective view features; generating, based on the set of 2D camera images, a 3D feature volume; and populating the 3D feature volume with the set of perspective view features to create a populated 3D feature volume.

Clause 22—The method of clause 21, wherein generating the 3D feature volume comprises: creating, based on each camera image pixel of the set of 2D camera images, a ray through a 3D space; identifying, for the ray corresponding to each camera image pixel of the set of 2D camera images, one or more points within the 3D space; creating, for the one or more points of each ray corresponding to the set of 2D camera images, a depth distribution; and generating the 3D feature volume based on the 3D space and the depth distribution of each ray corresponding to the set of 2D camera images.

Clause 23—The method of any of clauses 21-22, wherein the feature extractor is a first feature extractor, wherein the populated 3D feature volume is a first 3D feature volume, and wherein generating the set of BEV feature kernels comprises: applying a second feature extractor to extract, from the set of 3D point cloud frames, a second 3D feature volume; compressing the first 3D feature volume to generate a set of image data BEV feature kernels; compressing the second 3D feature volume to generate a set of position data BEV feature kernels; and fusing the set of image data BEV feature kernels and the set of position data BEV feature kernels to generate the set of BEV feature kernels.

Clause 24—The method of any of clauses 15-23, wherein generating the output comprises generating, based on the set of BEV feature kernels, the output to include a BEV representation of one or more objects within the 3D environment, and wherein the method further comprises using the output to control a device within the 3D environment based on the one or more objects within the 3D environment.

Clause 25—The method of any of clauses 15-24, further comprising: applying an encoder-decoder architecture to generate the set of BEV feature kernels; generating, based on the position data, kernelized ground truth corresponding to the output; comparing the kernelized ground truth with the output; and training the encoder-decoder architecture automatically based on comparing the kernelized ground truth with the output.

Clause 26—The method of any of clauses 15-25, further comprising using the output to control a vehicle.

Clause 27—The method of any of clauses 15-26, further comprising: controlling one or more cameras to capture the set of 2D camera images; and controlling a LiDAR system to capture the set of 3D point cloud frames.

Clause 28—A computer-readable medium stores instructions that, when applied by processing circuitry, causes the processing circuitry to convert a set of 2D camera images into a first 3D representation of a 3D environment corresponding to image data and position data, wherein a set of 3D point cloud frames comprises a second 3D representation of the 3D environment, wherein a memory is configured to store the image data and the position data, wherein the image data comprises the set of 2D camera images, and wherein the position data comprises the set of 3D point cloud frames. The instructions also cause the processing circuitry to generate, based on the first 3D representation and the second 3D representation, a set of BEV feature kernels in a continuous space and generate, based on the set of BEV feature kernels, an output.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and applied by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be applied by one or more processors, such as one or more DSPs, general purpose microprocessors, ASICs, FPGAs, or other equivalent integrated or discrete logic circuitry. Accordingly, the terms “processor” and “processing circuitry,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for processing image data and position data, the apparatus comprising:
a memory for storing the image data and the position data, wherein the image data comprises a set of two-dimensional (2D) camera images, and wherein the position data comprises a set of three-dimensional (3D) point cloud frames; and
processing circuitry in communication with the memory, wherein the processing circuitry is configured to:
convert the set of 2D camera images into a first 3D representation of a 3D environment corresponding to the image data and the position data, wherein the set of 3D point cloud frames comprises a second 3D representation of the 3D environment;
generate, based on the first 3D representation and the second 3D representation, a set of bird's eye view (BEV) feature kernels in a continuous space; and
generate, based on the set of BEV feature kernels, an output.

2. The apparatus of claim 1, wherein the processing circuitry is configured to generate the set of BEV feature kernels without relying on a BEV feature grid that includes a set of BEV feature cells each having a fixed dimension.

3. The apparatus of claim 1, wherein to convert the set of 2D camera images into the first 3D representation of the 3D environment, the processing circuitry is configured to apply a depth estimation unit to generate, based on the image data, a set of perspective view depth maps comprising the first 3D representation of the 3D environment corresponding to the image data.

4. The apparatus of claim 3, wherein the depth estimation unit comprises one or more encoders and one or more decoders, and wherein to apply the depth estimation unit to generate the set of perspective view depth maps, the processing circuitry is configured to apply the one or more encoders and one or more decoders to generate the set of perspective view depth maps to indicate a location of one or more objects indicated by the image data within the 3D environment.

5. The apparatus of claim 1, wherein the first 3D representation of the 3D environment comprises a set of perspective view depth maps generated based on the image data, and wherein to generate the set of BEV feature kernels, the processing circuitry is configured to:
apply a first feature extractor to extract, from the set of perspective view depth maps, a first set of 3D features;
apply a second feature extractor to extract, from the set of 3D point cloud frames, a second set of 3D features; and
generate, based on the first set of 3D features and the second set of 3D features, the set of BEV feature kernels.

6. The apparatus of claim 5, wherein to generate the set of BEV feature kernels, the processing circuitry is configured to:
fuse the first set of 3D features and the second set of 3D features to generate a fused set of 3D features;
apply, to the fused set of 3D features, a continuous convolution decoder to generate a processed fused set of 3D features; and
compress the processed fused set of 3D features to generate the set of BEV feature kernels.

7. The apparatus of claim 1, wherein to convert the set of 2D camera images into the first 3D representation of the 3D environment, the processing circuitry is configured to:
apply a feature extractor to extract, from the set of camera images, a set of perspective view features;
generate, based on the set of 2D camera images, a 3D feature volume; and
populate the 3D feature volume with the set of perspective view features to create a populated 3D feature volume.

8. The apparatus of claim 7, wherein to generate the 3D feature volume, the processing circuitry is configured to:
create, based on each camera image pixel of the set of 2D camera images, a ray through a 3D space;
identify, for the ray corresponding to each camera image pixel of the set of 2D camera images, one or more points within the 3D space;
create, for the one or more points of each ray corresponding to the set of 2D camera images, a depth distribution; and
generate the 3D feature volume based on the 3D space and the depth distribution of each ray corresponding to the set of 2D camera images.

9. The apparatus of claim 7, wherein the feature extractor is a first feature extractor, wherein the populated 3D feature volume is a first 3D feature volume, and wherein to generate the set of BEV feature kernels, the processing circuitry is configured to:
apply a second feature extractor to extract, from the set of 3D point cloud frames, a second 3D feature volume;
compress the first 3D feature volume to generate a set of image data BEV feature kernels;
compress the second 3D feature volume to generate a set of position data BEV feature kernels; and
fuse the set of image data BEV feature kernels and the set of position data BEV feature kernels to generate the set of BEV feature kernels.

10. The apparatus of claim 1, wherein to generate the output, the processing circuitry is configured to:
generate, based on the set of BEV feature kernels, the output to include a BEV representation of one or more objects within the 3D environment, and
wherein the processing circuitry is further configured to use the output to control a device within the 3D environment based on the one or more objects within the 3D environment.

11. The apparatus of claim 1, wherein the processing circuitry is configured to:
apply an encoder-decoder architecture to generate the set of BEV feature kernels;
generate, based on the position data, kernelized ground truth corresponding to the output;
compare the kernelized ground truth with the output; and
train the encoder-decoder architecture automatically based on comparing the kernelized ground truth with the output.

12. The apparatus of claim 1, wherein the processing circuitry and the memory are part of an advanced driver assistance system (ADAS).

13. The apparatus of claim 1, wherein the processing circuitry is configured to use the output to control a vehicle.

14. The apparatus of claim 1, wherein the apparatus further comprises:
one or more cameras configured to capture the set of 2D camera images; and
a Light Detection and Ranging (LiDAR) system configured to capture the set of 3D point cloud frames.

15. A method comprising:
converting a set of two-dimensional (2D) camera images into a first three-dimensional (3D) representation of a 3D environment corresponding to image data and position data, wherein a set of 3D point cloud frames comprises a second 3D representation of the 3D environment, wherein a memory is configured to store the image data and the position data, wherein the image data comprises the set of 2D camera images, and wherein the position data comprises the set of 3D point cloud frames;
generating, based on the first 3D representation and the second 3D representation, a set of bird's eye view (BEV) feature kernels in a continuous space; and
generating, based on the set of BEV feature kernels, an output.

16. The method of claim 15, further comprising generating the set of BEV feature kernels without relying on a BEV feature grid that includes a set of BEV feature cells each having a fixed dimension.

17. The method of claim 15, wherein converting the set of 2D camera images into the first 3D representation of the 3D environment comprises applying a depth estimation unit to generate, based on the image data, a set of perspective view depth maps comprising the first 3D representation of the 3D environment corresponding to the image data.

18. The method of claim 17, wherein the depth estimation unit comprises one or more encoders and one or more decoders, and wherein applying the depth estimation unit to generate the set of perspective view depth maps comprises applying the one or more encoders and one or more decoders to generate the set of perspective view depth maps to indicate a location of one or more objects indicated by the image data within the 3D environment.

19. The method of claim 15, wherein the first 3D representation of the 3D environment comprises a set of perspective view depth maps generated based on the image data, and wherein generating the set of BEV feature kernels comprises:
applying a first feature extractor to extract, from the set of perspective view depth maps, a first set of 3D features;
applying a second feature extractor to extract, from the set of 3D point cloud frames, a second set of 3D features; and
generating, based on the first set of 3D features and the second set of 3D features, the set of BEV feature kernels.

20. The method of claim 19, wherein generating the set of BEV feature kernels comprises:
fusing the first set of 3D features and the second set of 3D features to generate a fused set of 3D features;
applying, to the fused set of 3D features, a continuous convolution decoder to generate a processed fused set of 3D features; and
compressing the processed fused set of 3D features to generate the set of BEV feature kernels.

21. The method of claim 15, wherein converting the set of 2D camera images into the first 3D representation of the 3D environment comprises:
applying a feature extractor to extract, from the set of camera images, a set of perspective view features;
generating, based on the set of 2D camera images, a 3D feature volume; and
populating the 3D feature volume with the set of perspective view features to create a populated 3D feature volume.

22. The method of claim 21, wherein generating the 3D feature volume comprises:
creating, based on each camera image pixel of the set of 2D camera images, a ray through a 3D space;
identifying, for the ray corresponding to each camera image pixel of the set of 2D camera images, one or more points within the 3D space;
creating, for the one or more points of each ray corresponding to the set of 2D camera images, a depth distribution; and
generating the 3D feature volume based on the 3D space and the depth distribution of each ray corresponding to the set of 2D camera images.

23. The method of claim 21, wherein the feature extractor is a first feature extractor, wherein the populated 3D feature volume is a first 3D feature volume, and wherein generating the set of BEV feature kernels comprises:
applying a second feature extractor to extract, from the set of 3D point cloud frames, a second 3D feature volume;
compressing the first 3D feature volume to generate a set of image data BEV feature kernels;
compressing the second 3D feature volume to generate a set of position data BEV feature kernels; and
fusing the set of image data BEV feature kernels and the set of position data BEV feature kernels to generate the set of BEV feature kernels.

24. The method of claim 15,
wherein generating the output comprises generating, based on the set of BEV feature kernels, the output to include a BEV representation of one or more objects within the 3D environment, and
wherein the method further comprises using the output to control a device within the 3D environment based on the one or more objects within the 3D environment.

25. The method of claim 15, further comprising:
applying an encoder-decoder architecture to generate the set of BEV feature kernels;
generating, based on the position data, kernelized ground truth corresponding to the output;
comparing the kernelized ground truth with the output; and
training the encoder-decoder architecture automatically based on comparing the kernelized ground truth with the output.

26. The method of claim 15, further comprising using the output to control a vehicle.

27. The method of claim 15, further comprising:
controlling one or more cameras to capture the set of 2D camera images; and
controlling a Light Detection and Ranging (LiDAR) system to capture the set of 3D point cloud frames.

28. A computer-readable medium storing instructions that, when applied by processing circuitry, causes the processing circuitry to:
convert a set of two-dimensional (2D) camera images into a first three-dimensional (3D) representation of a 3D environment corresponding to image data and position data, wherein a set of 3D point cloud frames comprises a second 3D representation of the 3D environment, wherein a memory is configured to store the image data and the position data, wherein the image data comprises the set of 2D camera images, and wherein the position data comprises the set of 3D point cloud frames;
generate, based on the first 3D representation and the second 3D representation, a set of bird's eye view (BEV) feature kernels in a continuous space; and
generate, based on the set of BEV feature kernels, an output.
